(19) United States
(12) Patent Application Publication
(10) Pub. No.: US 2026/0180694 A1
(43) Pub. Date: Jun. 25, 2026

(54) ONLINE MILLIMETER WAVE DIGITAL PREDISTORTION CALIBRATION

(71) Applicant: QUALCOMM Incorporated, San Diego, CA (US)

(72) Inventors: Damin CAO, San Diego, CA (US); Kyle Alexander DOUGLAS, San Diego, CA (US); Igor GUTMAN, Hod HaSharon (IL); Min Soo SIM, San Diego, CA (US); Shrenik PATEL, San Diego, CA (US); Carl HARDIN, Encinitas, CA (US); Yushi CAO, Coquitlam (CA); Chinmaya MISHRA, San Diego, CA (US); Chuan WANG, San Diego, CA (US); Alexander SVERDLOV, Rehovot (IL); Wei ZHAO, San Diego, CA (US); Tao LUO, San Diego, CA (US)

(21) Appl. No.: 19/000,496

(22) Filed: Dec. 23, 2024

(51) Int. Cl. H04B 17/14; H04B 1/04

(52) U.S. Cl. CPC H04B 17/14; H04B 1/0475

(57) ABSTRACT

Aspects described herein include devices and methods for facilitating digital predistortion calibration. For example, a communication device can include an antenna array; a plurality of transmit elements; a plurality of receive elements, wherein each receive element is coupled to an associated antenna element of the plurality of antenna elements; and control circuitry, the control circuitry configured to: determine a set of transmit-receive element pairs for online calibration of the communication device, wherein a quantity of transmit elements in the set is less than a quantity of transmit elements in the plurality of transmit elements, and wherein a quantity of receive elements in the set is less than a quantity of receive elements in the plurality of transmit elements; and apply a second calibration setting to the communication device during online operation based on a respective near field measurement of each transmit-receive element pair during the online operation.

### FIELD

The present disclosure relates generally to electronics and wireless communications. For example, aspects of the present disclosure relate to online calibration of communication devices or systems (e.g., millimeter wave (mmW) communication devices or systems).

### BACKGROUND

Wireless communication devices and technologies are becoming ever more prevalent. Wireless communication devices generally transmit and receive communication signals. A communication signal is typically processed by a variety of different components and circuits. In some modern communication systems, phase array antennas are used to improve system operation with improved link budgets, system capacity, beamforming, multiple-in multiple-out (MIMO) communications, and other such system operations. Supporting such systems can involve complex system design choices, and managing complex interactions among device elements and signals.

### SUMMARY

Various implementations of systems, methods, and devices within the scope of the appended claims each have several aspects, no single one of which is solely responsible for the desirable attributes described herein. Without limiting the scope of the appended claims, some prominent features are described herein.

Aspects described herein include devices, wireless communication apparatuses, circuits, and modules supporting wireless communications, such as at millimeter wave frequencies. According to at least one example, a method is provided for performing an online calibration for a large array. The method includes: determining, at a communication device, a set of transmit-receive element pairs for online calibration of the communication device, wherein the communication device comprises a plurality of transmit elements coupled to a plurality of antenna elements and a plurality of receive elements coupled to the plurality of antenna elements, wherein a quantity of transmit elements in the set is less than a quantity of transmit elements in the plurality of transmit elements, and wherein a quantity of receive elements in the set is less than a quantity of receive elements in the plurality of transmit elements; and applying a calibration setting to the communication device during online operation based on a respective near field measurement of each transmit-receive element pair during the online operation, the calibration setting based on a respective predistortion coefficient for each transmit-receive element pair.

In another example, a communication device is configured to perform an online calibration. The communication device, comprises: an antenna array comprising a plurality of antenna elements; a plurality of transmit elements, wherein each transmit element is coupled to a corresponding antenna element of the plurality of antenna elements; a plurality of receive elements, wherein each receive element is coupled to an associated antenna element of the plurality of antenna elements; and control circuitry coupled to the plurality of transmit elements and the plurality of receive elements, the control circuitry configured to: determine a set of transmit-receive element pairs for online calibration of the communication device, wherein a quantity of transmit elements in the set is less than a quantity of transmit elements in the plurality of transmit elements, and wherein a quantity of receive elements in the set is less than a quantity of receive elements in the plurality of transmit elements; and apply a calibration setting to the communication device during online operation based on a respective near field measurement of each transmit-receive element pair during the online operation, the calibration setting based on a respective predistortion coefficient for each transmit-receive element pair.

In some aspects, the apparatuses described above can function in a system that includes a mobile device with a camera for capturing one or more pictures. In some aspects, the apparatuses described above can include a display screen for displaying one or more images or interface displays. In some aspects, additional wireless communication circuitry is provided. The summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a diagram showing an example of a wireless communication system communicating with a user equipment (UE) that can be implemented according to aspects described herein;

FIG. 2A is a block diagram showing an example of a wireless device of a base station in accordance with some aspects of the disclosure;

FIG. 2B is a block diagram showing a wireless device of a base station in accordance with some aspects of the disclosure;

FIG. 2C is a block diagram showing in greater detail some of the components of FIG. 2B;

FIG. 3 is a flow diagram illustrating a method for calibrating a mmW communication device using offline and online techniques in accordance with aspects of the present disclosure;

FIG. 4 is a conceptual diagram of a large array of antenna elements and identifying different transmit-receive groups and a loopback associated with a representative transmit element in accordance with some aspects of the disclosure;

FIG. 5 is a flow diagram illustrating a method for selecting a receive element for a representative transmit element in accordance with aspects of the present disclosure;

FIG. 6 is a block diagram of an mmW communication device configured to forward correct power droop based on representative transmit element in accordance with some aspects of the disclosure;

FIG. 7A illustrates aspects of a mmW communication device involved with predistortion calibration in accordance with aspects described herein;

FIG. 7B illustrates aspects of a mmW communication device involved with predistortion calibration in accordance with aspects described herein;

FIG. 8 illustrates aspects of a mmW communication device including transmit correction and a predistortion calibration in accordance with some aspects of the disclosure;

FIG. 9A illustrates a power droop of a mmW communication device using static calibrations;

FIG. 9B illustrates a power droop of a mmW communication device using offline and online calibrations in accordance with some aspects of the disclosure;

FIGS. 10A, 10B, 10C and 10D are block diagrams illustrating a millimeter wave radio frequency (RF) module in accordance with some aspects of the disclosure;

FIG. 11 is a flow chart describing an example of the operation of a method for calibrating an mmW communication device in accordance with some aspects of the disclosure; and

FIG. 12 is a functional block diagram of an apparatus including a mmW communication device including online calibration capabilities in accordance with some aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The detailed description set forth below in connection with the appended drawings is intended as a description of example aspects and implementations and is not intended to represent the only implementations in which the invention may be practiced. The detailed description includes specific details for the purpose of providing a thorough understanding of the example aspects and implementations. In some instances, some devices are shown in block diagram form. Drawing elements that are common among the following figures may be identified using the same reference numerals.

The progression of wireless communication infrastructure, such as for Third Generation Partnership Project (3GPP) fifth generation (5G) millimeter wavelength (mmW) systems and 5G standards for cellular communications involve increasing complexity of frequency combinations and communication throughput options. Calibration of mmW elements to meet performance targets of mmW operations often relies on self-calibration because of the large cost of independent test equipment, due to measurement uncertainty associated with over-the-air radiation-based mmW measurements, and due to lack of test access to antenna connectors.

Digital predistortion (DPD) calibration involves signal processing with a path for a loopback transmit (TX) signal so that a modem can process samples captured for DPD training. Some feedback receivers (FBRx) can be designed to loopback a transmission (Tx) signal to receive (Rx) elements in sub-6 GHz frequencies, but such FBRX increases device costs and size. Further, a mmW FBRX may be particularly costly due to the need for each power amplifier in a mmW beam forming array to include a separate FBRX path for effective testing.

A large array system of transmit and receive elements (e.g., antennas configured for transmission and reception, and optionally transceivers associated with such antennas) associated with base stations (e.g., base stations, evolved node B (eNB), next generation node B (gNB), etc.) may transmit on the downlink to wireless stations (e.g., also referred to as a user equipment (UE)) and receive on the uplink from UEs. In some cases, a large array can include 128 individual transmit and receive elements and transmit an effective isotropic radiated power (EIRP) to downlink UEs. Large arrays may include a greater or fewer number of transmit and receive elements.

There are significant challenges in EIRP of large array systems. For example, EIRP can be increased by adding more transmit and receive elements. However, adding more transmit and receive elements increases hardware cost and power consumption costs. Large array systems are also sensitive to temperature because they are often used in outdoor environments, which have a wider range of environmental conditions as compared to indoor environments. In addition, large array systems require higher power transmission and generate more heat as compared to indoor environments. Power amplifier performance and efficiency are also directly correlated to the temperature of the semiconductor materials.

Large array systems also have more strict reliability and lifespan requirements. A large array system may be designed for 10 years of operation, while a conventional UE may be designed for 5 years of operation. Transmission applies stress to the transmit elements and ages the transmit elements over time at a different rate than the corresponding receive elements. For example, downlink duty cycle of the transmit elements in a large array system (e.g., an gNB) may be higher than the uplink duty cycle of the transmit elements in a small array system (e.g., a UE).

Downlink bandwidth of transmit elements also need to support larger bandwidths as compared to uplink. For example, a femto cell may support over 500 MHz of operation. Higher bandwidth operation may negatively affect a memory effect in a transmit element that can affect error vector magnitude (EVM) and adjacent channel leakage ratio (ACLR). Larger bandwidths may also increase a power droop performance, which is a non-linear power response over a bandwidth. Power droop can also have a memory effect in the large array system, which reduces the performance of the large array system.

Systems, apparatuses, processes (also referred to as methods), and computer-readable media (collectively referred to as “systems and techniques”) are described herein for increasing the power output per transmit element (Pbump) of communication devices or systems, for example which have large antenna array systems (e.g., mmW communication devices or systems), using DPD techniques. In one aspect, the systems and techniques can perform offline calibration (wherein a first calibration setting can be determined) and online calibration (wherein a second calibration setting can be determined) of a communication device having a large antenna array system. In the offline calibration, representative transmit-receive element pairs (also referred to as loopback transmit-receive element pairs or loopback pairs) of the communication device can be selected based on various criteria in the large antenna array system. For example, a medium performance transmit element can be selected and a corresponding receive element that has performance exceeding a certain threshold can be selected as a representative transmit element and corresponding receive element for the representative transmit element. In some aspects, the power droop of each representative transmit-receive element pair is measured offline, and a calibration process is implemented to determine a first calibration setting that can be applied to the communication device to correct the power droop for online operation.

In addition, the systems and techniques can be configured to measure the performance of the transmit-receive element pairs to generate power droop correction equalizer settings (e.g., first calibration settings) and a near field loopback and generate predistortion coefficients (e.g., second calibration settings) during online operation of the communication device. In some aspects, a group of transmit elements are represented by a representative transmit element and the group is configured to use the predistortion coefficients during online operation to correct device performance based on electrical property deviation (e.g., due to temperature changes, aging, etc.) during online operation. In some cases, using the calibration systems and techniques described herein, the Pbump per transmit element may be increased (e.g., increased by 3.5 decibels (dB)). In such cases, fewer transmit and receive elements can be required for a large array having the same effective radiated power. In other cases, the increased Pbump can increase the total radiated power output by a large array (e.g., by 3.5 dB). The disclosed systems and techniques can also adapt online performance based on dynamic conditions, account for device aging, and account for process corner variations.

Further details regarding aspects described herein are provided with respect to the figures below.

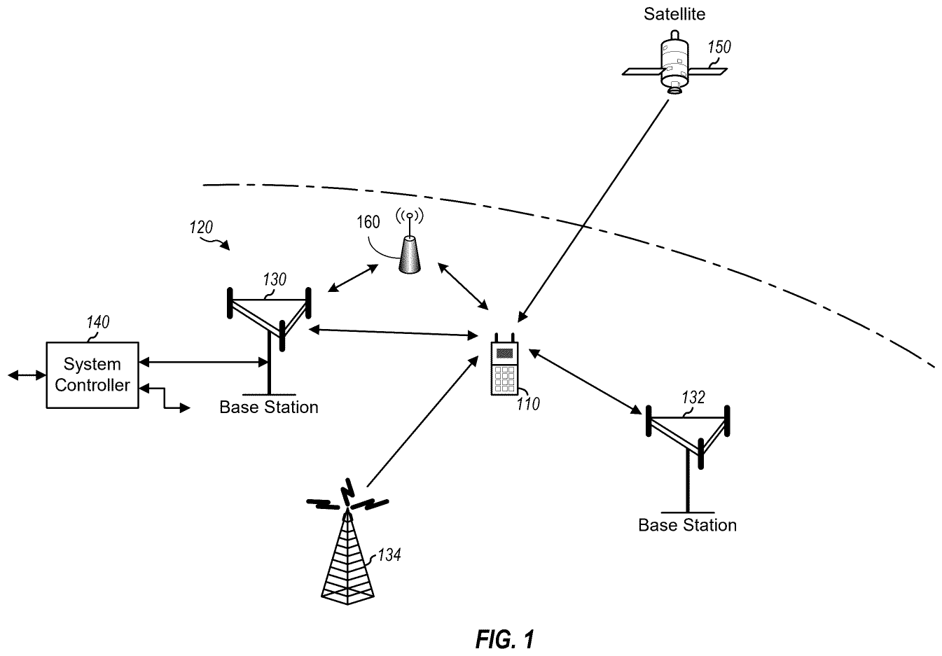

FIG. 1 is a diagram showing a UE 110 communicating with a wireless communication system 120. The wireless communication system 120 may be a Long Term Evolution (LTE) system, a Code Division Multiple Access (CDMA) system, a Global System for Mobile Communications (GSM) system, a wireless local area network (WLAN) system, a 5G NR (new radio) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including base station 130, base station 132, and a system controller 140. In general, a wireless communication system may include any number of base stations and any set of network entities.

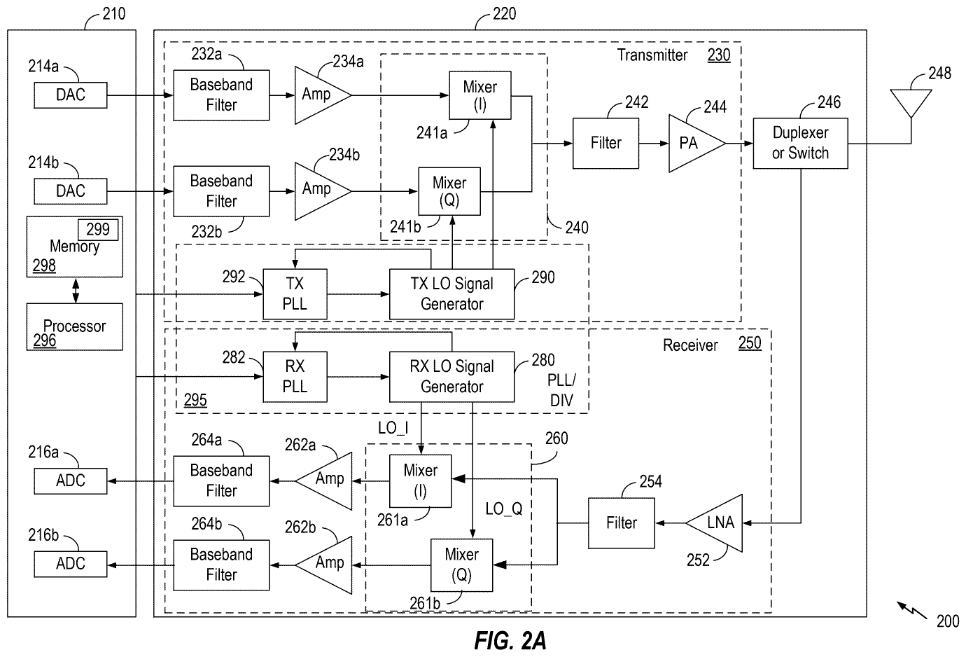

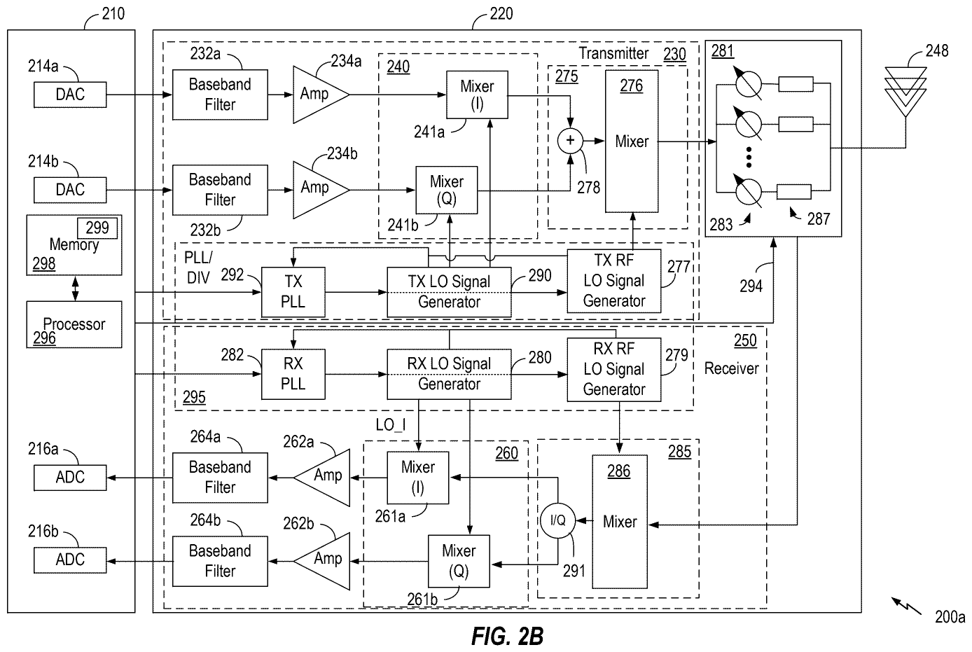

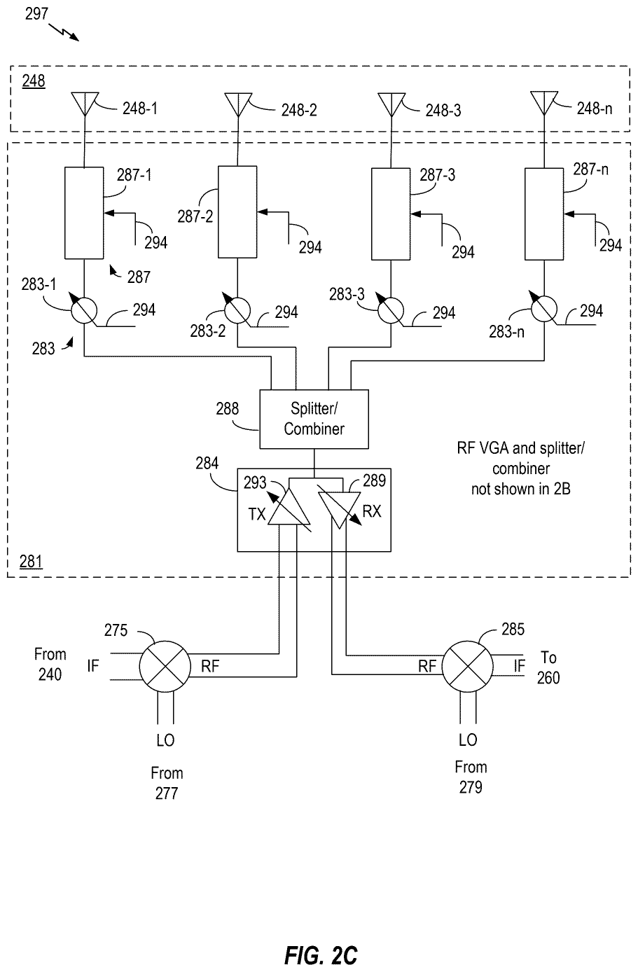

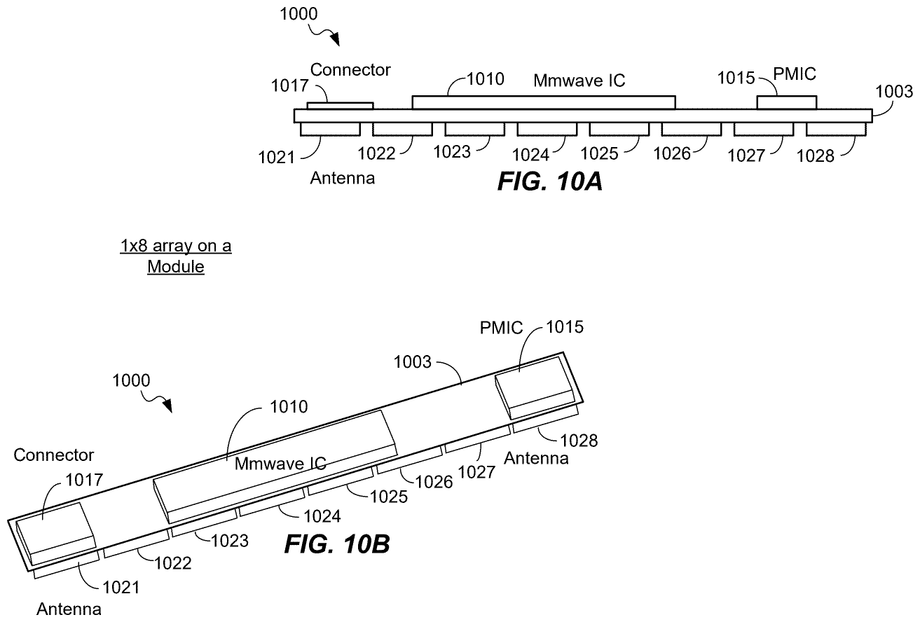

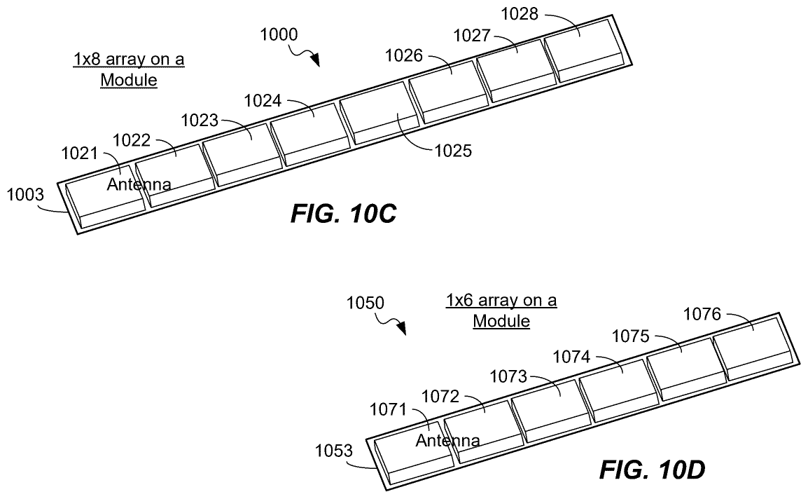

The UE 110 may also be referred to as a user equipment (UE), a mobile station, a terminal, an access terminal, a subscriber unit, a station, etc. UE 110 may be a cellular phone, a smartphone, a tablet, a wireless modem, a personal digital assistant (PDA), a handheld device, a laptop computer, a smartbook, a netbook, a tablet, a cordless phone, a medical device, a device configured to connect to one or more other devices (for example through the internet of things), a wireless local loop (WLL) station, a Bluetooth device, etc. UE 110 may communicate with wireless communication system 120. UE 110 may also receive signals from broadcast stations (e.g., a broadcast station 134) and/or signals from satellites (e.g., a satellite 150 in one or more global navigation satellite systems (GNSS), etc.). UE 110 may support one or more radio technologies for wireless communication such as LTE, WCDMA, CDMA 1X, EVDO, TD-SCDMA, GSM, 802.11, 5G, communications with a non-terrestrial network, etc. The UE 110 may additionally include millimeter wave (mmW) communication elements for transmitting and receiving signals using mmW wireless signals. Such mmW communication elements can be part of mmW modules as described in FIGS. 10A-D and/or can include mmW communication circuitry as described in FIGS. 2A-C, 5, 6, and 7. Aspects described herein include operations and systems for calibration of digital pre-distortion systems in such mmW communication elements in wireless devices such as the UE 110.

The wireless communication system 120 may also include a access point (AP) 160. In some aspects, the AP 160 comprises part of a WLAN. In some aspects, the AP 160 may be configured as a customer premises equipment (CPE), which may be in communication with a base station 130 and a UE 110, or other devices in the wireless communication system 120. In some aspects, the CPE may be configured to communicate with the UE 110 using WLAN signaling and to interface with the base station 130 based on such communication instead of the UE 110 directly communicating with the base station 130. In some aspects where the AP 160 is configured to communicate using WLAN signaling, a WLAN signal may include WiFi, or other communication signals.

Any of the base stations (e.g., 130-132), broadcast station 134, the AP 160, a CPE, or any other device capable of wireless communication in the wireless communication system 120 may additionally include millimeter wave (mmW) communication elements for transmitting and receiving signals using mmW wireless signals. Such mmW communication elements can be part of mmW modules as described in FIGS. 10A-D and/or can include mmW communication circuitry as described in FIGS. 2A-C, 5, 6, and 7. Aspects described herein include operations and systems for calibration of digital pre-distortion systems in such mmW communication elements in wireless devices such as the base stations (e.g., 130-134), the AP 160, a CPE, etc.

UE 110, base stations 130-132, broadcast station 134, and/or the AP 160 may support carrier aggregation, for example as described in one or more LTE or 5G standards. In some aspects, a single stream of data is transmitted over multiple carriers using carrier aggregation, for example as opposed to separate carriers being used for respective data streams. UE 110, base stations 130-132, broadcast station 134, and/or the AP 160 may be able to operate in a variety of communication bands including, for example, those communication bands used by LTE, WiFi, 5G or other communication bands, over a wide range of frequencies. UE 110 may also be capable of communicating directly with other wireless devices without communicating through a network.

In general, carrier aggregation (CA) may be categorized into two types—intra-band CA and inter-band CA. Intra-band CA refers to operation on multiple carriers within the same band. Inter-band CA refers to operation on multiple carriers in different bands.

FIG. 2A is a block diagram showing an example of a wireless device 200 in accordance with some aspects of the disclosure. The wireless device 200 may, for example, be an aspect of the base station 130 or 132, or of the broadcast station 134, illustrated in FIG. 1.

FIG. 2A shows an example of a transceiver 220 having a transmitter 230 and a receiver 250. In general, the conditioning of the signals in the transmitter 230 and the receiver 250 may be performed by one or more stages of amplifier, filter, upconverter, downconverter, etc. These circuit blocks may be arranged differently from the configuration shown in FIG. 2A. Furthermore, other circuit blocks not shown in FIG. 2A may also be used to condition the signals in the transmitter 230 and receiver 250. Unless otherwise noted, any signal in FIG. 2A, or any other figure in the drawings, may be either single-ended or differential. Some circuit blocks in FIG. 2A may also be omitted.

In the example shown in FIG. 2A, wireless device 200 generally comprises the transceiver 220 and a data processor 210. The data processor 210 may include a processor 296 operatively coupled to a memory 298. The memory 298 may be configured to store data and program codes shown generally using reference numeral 299, and may generally comprise analog and/or digital processing components. The transceiver 220 includes a transmitter 230 and a receiver 250 that support bi-directional communication. In general, wireless device 200 may include any number of transmitters and/or receivers for any number of communication systems and frequency bands. All or a portion of the transceiver 220 may be implemented on one or more analog integrated circuits (ICs), radio frequency (RF) ICs (RFICs), mixed-signal ICs, etc.

A transmitter or a receiver may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the example shown in FIG. 2A, transmitter 230 and receiver 250 are implemented with the direct-conversion architecture.

In the transmit path, the data processor 210 processes data to be transmitted and provides in-phase (I) and quadrature (Q) analog output signals to the transmitter 230. In an exemplary aspect, the data processor 210 includes digital-to-analog-converters (DACs) 214a and 214b for converting digital signals generated by the data processor 210 into the I and Q analog output signals, e.g., I and Q output currents, for further processing. In other aspects, the DACs 214a and 214b are included in the transceiver 220 and the data processor 210 provides data (e.g., for I and Q) to the transceiver 220 digitally.

Within the transmitter 230, lowpass filters 232a and 232b filter the I and Q analog transmit signals, respectively, to remove undesired images caused by the prior digital-to-analog conversion. Amplifiers (Amp) 234a and 234b amplify the signals from lowpass filters 232a and 232b, respectively, and provide I and Q baseband signals. An upconverter 240 having upconversion mixers 241a and 241b upconverts the I and Q baseband signals with I and Q transmit (TX) local oscillator (LO) signals from a TX LO signal generator 290 and provides an upconverted signal. A filter 242 filters the upconverted signal to remove undesired images caused by the frequency upconversion as well as noise in a receive frequency band. A power amplifier (PA) 244 amplifies the signal from filter 242 to obtain the desired output power level and provides a transmit RF signal. The transmit RF signal is routed through a duplexer or switch 246 and transmitted via an antenna array 248. While examples discussed herein utilize I and Q signals, those of skill in the art will understand that components of the transceiver may be configured to utilize polar modulation.

In the receive path, the antenna array 248 receives communication signals and provides a received RF signal, which is routed through duplexer or switch 246 and provided to a low noise amplifier (LNA) 252. The duplexer or switch 246 is designed to operate with a specific RX-to-TX duplexer frequency separation, such that RX signals are isolated from TX signals. The received RF signal is amplified by LNA 252 and filtered by a filter 254 to obtain a desired RF input signal. Downconversion mixers 261a and 261b in a downconverter 260 mix the output of filter 254 with I and Q receive (RX) LO signals (i.e., LO_I and LO_Q) from an RX LO signal generator 280 to generate I and Q baseband signals. The I and Q baseband signals are amplified by amplifiers 262a and 262b and further filtered by lowpass filters 264a and 264b to obtain I and Q analog input signals, which are provided to data processor 210. In the exemplary aspect shown, the data processor 210 includes analog-to-digital-converters (ADCs) 216a and 216b for converting the analog input signals into digital signals to be further processed by the data processor 210. In some aspects, the ADCs 216a and 216b are included in the transceiver 220 and provide data to the data processor 210 digitally.

In FIG. 2A, TX LO signal generator 290 generates the I and Q TX LO signals used for frequency upconversion, while RX LO signal generator 280 generates the I and Q RX LO signals used for frequency downconversion. Each LO signal is a periodic signal with a particular fundamental frequency. A phase locked loop (PLL) 292 receives timing information from data processor 210 and generates a control signal used to adjust the frequency and/or phase of the TX LO signals from LO signal generator 290. Similarly, a PLL 282 receives timing information from data processor 210 and generates a control signal used to adjust the frequency and/or phase of the RX LO signals from LO signal generator 280.

In an exemplary aspect, the RX PLL 282, the TX PLL 292, the RX LO signal generator 280, and the TX LO signal generator 290 may alternatively be combined into a single LO generator circuit 295, which may include common or shared LO signal generator circuitry to provide the TX LO signals and the RX LO signals. Alternatively, separate LO generator circuits may be used to generate the TX LO signals and the RX LO signals.

Certain components of the transceiver 220 are functionally illustrated in FIG. 2A, and the configuration illustrated therein may or may not be representative of a physical device configuration in certain implementations. For example, as described above, transceiver 220 may be implemented in various integrated circuits (ICs), RFICs, mixed-signal ICs, etc. In some aspects, the transceiver 220 is implemented on a substrate or board such as a printed circuit board (PCB) having various modules, chips, and/or components. For example, the power amplifier 244, the filter 242, and the duplexer or switch 246 may be implemented in separate modules or as discrete components, while the remaining components illustrated in the transceiver 220 may be implemented in a single transceiver chip.

The power amplifier 244 may comprise one or more stages comprising, for example, driver stages, power amplifier stages, or other components, that can be configured to amplify a communication signal on one or more frequencies, in one or more frequency bands, and at one or more power levels. Depending on various factors, the power amplifier 244 can be configured to operate using one or more driver stages, one or more power amplifier stages, one or more impedance matching networks, and can be configured to provide good linearity, efficiency, or a combination of good linearity and efficiency.

In an exemplary aspect in a super-heterodyne architecture, the filter 242, PA 244, LNA 252 and filter 254 may be implemented separately from other components in the transmitter 230 and receiver 250, and may be implemented on a millimeter wave integrated circuit. An example super-heterodyne architecture is illustrated in FIG. 2B.

FIG. 2B is a block diagram showing a wireless device 200a in accordance with some aspects of the disclosure. Certain components, for example which may be indicated by identical reference numerals, of the wireless device 200a in FIG. 2B may be configured similarly to those in the wireless device 200 shown in FIG. 2A and the description of identically numbered items in FIG. 2B will not be repeated.

The wireless device 200a is an example of a heterodyne (or superheterodyne) architecture in which the upconverter 240 and the downconverter 260 are configured to process a communication signal between baseband and an IF. For example, the upconverter 240 may be configured to provide an IF signal to an upconverter 275. In an exemplary aspect, the upconverter 275 may comprise summing function 278 and upconversion mixer 276. The summing function 278 combines the I and the Q outputs of the upconverter 240 and provides a non-quadrature signal to the mixer 276. The non-quadrature signal may be single ended or differential. The mixer 276 is configured to receive the IF signal from the upconverter 240 and TX RF LO signals from a TX RF LO signal generator 277, and provide an upconverted RF signal to phase shift circuitry 281. While PLL 292 is illustrated in FIG. 2B as being shared by the signal generators 290, 277, a respective PLL for each signal generator may be implemented.

Components in the phase shift circuitry 281 may comprise one or more adjustable or variable phased array elements, and may receive one or more control signals from the data processor 210 over connection 294 and operate the adjustable or variable phased array elements based on the received control signals.

The phase shift circuitry 281 comprises phase shifters 283 and phased array elements 287. Although three phase shifters 283 and three phased array elements 287 are shown for ease of illustration, the phase shift circuitry 281 may comprise more or fewer phase shifters 283 and phased array elements 287.

Each phase shifter 283 may be configured to receive the RF transmit signal from the upconverter 275, alter the phase by an amount, and provide the RF signal to a respective phased array element 287. Each phased array element 287 may comprise transmit and receive circuitry including one or more filters, amplifiers, driver amplifiers, and power amplifiers. In some aspects, the phase shifters 283 may be incorporated within respective phased array elements 287.

The output of the phase shift circuitry 281 is provided to an antenna array 248. In an exemplary aspect, the antenna array 248 comprises a number of antennas that typically correspond to the number of phase shifters 283 and phased array elements 287, for example such that each antenna element is coupled to a respective phased array element 287. In an exemplary aspect, the phase shift circuitry 281 and the antenna array 248 may be referred to as a phased array.

In a receive direction, an output of the phase shift circuitry 281 is provided to a downconverter 285. In an exemplary aspect, the downconverter 285 may comprise an I/Q generation function 291 and a downconversion mixer 286. In an exemplary aspect, the mixer 286 downconverts the receive RF signal provided by the phase shift circuitry 281 to an IF signal according to RX RF LO signals provided by an RX RF LO signal generator 279. The I/Q generation function 291 receives the IF signal from the mixer 286 and generates I and Q signals for the downconverter 260, which downconverts the IF signals to baseband, as described above. While PLL 282 is illustrated in FIG. 2B as being shared by the signal generators 280, 279, a respective PLL for each signal generator may be implemented.

In some aspects, the upconverter 275, downconverter 285, and the phase shift circuitry 281 are implemented on a common IC. In some aspects, the summing function 278 and the I/Q generation function 291 are implemented separate from the mixers 276 and 286 such that the mixers 276, 286 and the phase shift circuitry 281 are implemented on the common IC, but the summing function 278 and I/Q generation function 291 are not (e.g., the summing function 278 and I/Q generation function 291 are implemented in another IC coupled to the IC having the mixers 276, 286). In some aspects, the LO signal generators 277, 279 are included in the common IC. In some aspects in which phase shift circuitry is implemented on a common IC with 276, 286, 277, 278, 279, and/or 291, the common IC and the antenna array 248 are included in a module, which may be coupled to other components of the transceiver 220 via a connector. In some aspects, the phase shift circuitry 281, for example, a chip on which the phase shift circuitry 281 is implemented, is coupled to the antenna array 248 by an interconnect. For example, components of the antenna array 248 may be implemented on a substrate and coupled to an integrated circuit implementing the phase shift circuitry 281 via a flexible printed circuit.

In some aspects, both the architecture illustrated in FIG. 2A and the architecture illustrated in FIG. 2B may be implemented in the same device. For example, a wireless device 200 may be configured to communicate with signals having a frequency below about 10 GHz (or 24 GHz in some configurations) using the architecture illustrated in FIG. 2A and to communicate with signals having a frequency above about 10 GHz (or 24 GHz in some configurations) using the architecture illustrated in FIG. 2B. In devices in which both architectures are implemented, one or more components of FIGS. 2A and 2B that are identically numbered may be shared between the two architectures. For example, both signals that have been downconverted directly to baseband from RF and signals that have been downconverted from RF to baseband via an IF stage may be filtered by the same baseband filter (e.g., the filter 264a, 264b). In other aspects, a first version of the filter is included in the portion of the wireless device which implements the architecture of FIG. 2A and a second version of the filter is included in the portion of the wireless device which implements the architecture of FIG. 2B. In some examples, phase shift circuitry is implemented in a direct conversion architecture, for example by omitting the upconverter 240 and the downconverter 260.

FIG. 2C is a block diagram 297 showing in greater detail an aspect of some of the components of FIG. 2B. In an exemplary aspect, the upconverter 275 provides an RF transmit signal to the phase shift circuitry 281 and the downconverter 285 receives an RF receive signal from the phase shift circuitry 281. In an exemplary aspect, the phase shift circuitry 281 comprises a variable gain amplifier (VGA) 284 at RF frequencies, a splitter/combiner 288, the phase shifters 283 and the phased array elements 287. In an exemplary aspect, the phase shift circuitry 281 may be implemented on a millimeter-wave integrated circuit (mmWIC). In some such aspects, the upconverter 275 and/or the downconverter 285 (or just the mixers 276, 286) are also implemented on the mmWIC. The mmWIC may be an RFIC configured to support mmW frequencies. In an exemplary aspect, the RF variable gain amplifier (VGA) 284 may include a TX VGA 293 and an RX VGA 289. In some aspects, the TX VGA 293 and the RX VGA 289 may be implemented independently. In other aspects, the VGA 284 is bidirectional. In an exemplary aspect, the splitter/combiner 288 may be an example of a power distribution network and a power combining network. In some aspects, the splitter/combiner 288 may be implemented as a single component or as a separate signal splitter and signal combiner. The phase shifters 283 are coupled to respective phased array elements 287. Each respective phased array element 287 is coupled to a respective antenna element in the antenna array 248. In some examples, multiple phased array elements 287 are coupled to each of the antenna elements in the antenna array 248, for example such that each antenna element can operate in a plurality of polarizations. In an exemplary aspect, phase shifters 283 and the phased array elements 287 receive control signals from the data processor 210 over connection 294. The exemplary aspect shown in FIG. 2C comprises a 1×4 array having four phase shifters 283-1, 283-2, 283-3 and 283-n, four phased array elements 287-1, 287-2, 287-3 and 287-n, and four antennas 248-1, 248-2, 248-3 and 248-n. However, a 1×4 phased array is shown for example only, and other configurations, such as 1×2, 1×6, 1×8, 2×3, 2×4, or other configurations are possible. Each phased array element 287 can include transmit and receive circuitry (not illustrated). Each of the phase shifters 283 may be shared by the transmit and receive circuitry of a respective phased array element, or respective phase shifters for transmit and receive functions may be implemented for each of the phased array elements 287. Further, while the phase shifters 283 are illustrated as being signal path phase shifters, other examples include LO-path phase shifting, for example when respective mixers for each phased array element 287 are implemented.

Transmission and receive paths involved in transmitting and receiving mmW signals via phased array elements and antennas such as the antennas 248-1 through 248-n can introduce signal distortion associated with system non-linearity.

In some aspects, performing online DPD training of each element would consume a significant amount of time and power. For example, performing a calibration at each unique combination of 128 different transmit and receive elements of a large array is exponential and requires N transmissions and N^{N-1} calculations, with N being the number of transmit and receive elements. However, a static calibration cannot account for device variation based on location, environmental effects during deployment, process corners, and aging of the semiconductor devices. In addition, the physical location of the mmWICs also can affect performance and aging because temperature and other effects (such as neighboring mmWICs) can be affected based on physical location. As an example, a mmWIC in the center of the large array may be exposed to more heat than a mmWIC at a corner of the large array. In addition, the mmWICs can respond differently based on process corner (e.g., fast process, slow process, etc.) during semiconductor manufacturing.

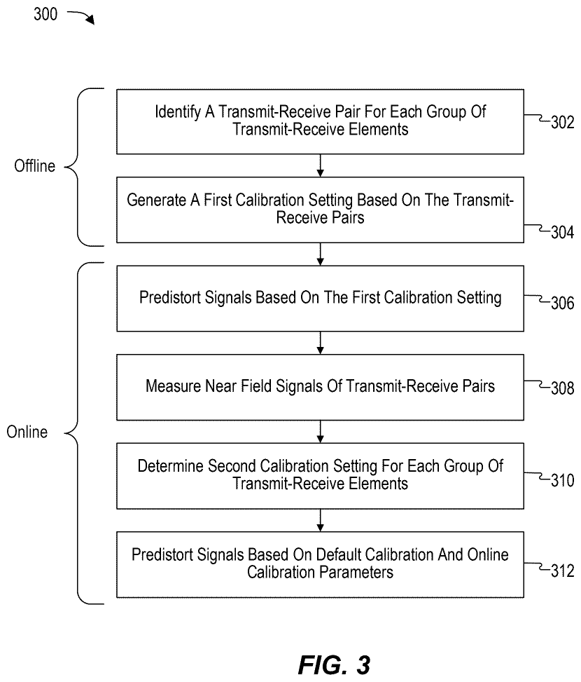

In some aspects, the transmit elements of the large array may be divided into different groups and a representative transmit element and corresponding receive element for the representative transmit element (also referred to as a transmit-receive element pair, a loopback transmit-receive element pair, or a loopback pair) is mapped to each group. In some cases, a method (e.g., as described below in FIG. 3) may be performed to calibrate the large array offline and online. An online operation refers to activities and functionalities of a device (e.g., a large array of elements of a mmW base station) when connected to a network and operational for end users. In some cases, online operation may include a mission mode. An offline operation refers to activities that are performed before and in connection the large array entering online mode. For example, an offline operation may be a calibration or other measurement performed during manufacturing of the large array. In the aspects further described below, a near field loopback may be performed based on the representative transmit element and corresponding receive element for the representative transmit element to calibrate the large array during online operation.

FIG. 3 is a flow diagram illustrating a method for calibrating a mmW communication device using offline and online techniques in accordance with aspects of the present disclosure. In some aspects, the operations of the method 300 can be performed by control circuitry and elements of a mmW communication device as described herein. In some aspects, the operations of the method 300 can be implemented as instructions (e.g., reference numeral 299) stored in a computer readable storage medium (e.g., memory 298) that, when executed by processing or control circuitry of a device (e.g., processor 296), cause the wireless device 200 to perform the described operations. The blocks in the method 300 can be performed in or out of the order shown, and in some aspects, can be performed at least in part in parallel.

In some aspects, at block 302 the mmW communication device is configured to identify a representative transmit element for each group of transmit-receive elements and corresponding receive element for the representative transmit element for each group. In some aspects, transmit elements are separated into groups and performance deviation of different elements can be minimized based on selection of a representative transmit element and a corresponding receive element for the representative transmit element. For example, a medium transmit element (described in further detail below) of a group may be selected, and corresponding receive element for that particular medium transmit element may be identified based on measurements (e.g., an NMSE measurement). In some aspects, signals transmitted from a medium transmit element are approximately representative of signals transmitted from multiple (e.g., all or a majority of) elements in a large array (e.g., 128-element array) because the signals transmitted from multiple elements average out and the total signal is nearly equivalent to a signal from a representative transmit element. In addition, each signal path may be impaired due to various parasitic and non-linear effects. For example, a signal path can be impaired due to the non-linearity of the power amplifier, thermal noise, phase noise, memory effect, etc. The impairments are averaged out and may have insignificant effects in a large array and the total signal may be roughly equivalent to a signal from a medium transmit element. In some aspects, medium transmit elements are selected as the representative transmit element of a group to trade off performance and complexity (e.g., instead of testing every transmit element).

At block 304, the mmW communication device is configured to generate a first calibration setting based on the representative transmit elements and corresponding receive element for each representative transmit element. For example, in a 128-element array, 16 different groups (of 8 elements each) can be logically created and each group has a representative transmit element, and the representative transmit element is paired with a corresponding receive element in any of the groups (described further below). In some aspects, calibration parameters may be generated for each representative transmit element and corresponding receive element for the representative transmit element, yielding sixteen different calibration parameters.

The groups may be identified or created in any number of ways. In some examples, a group is created for each separate substrate on which antennas are implemented, with all antennas on a common substrate being in the same group. In other examples, a group is created for each mmWIC associated with the array such that all antennas in a respective group are coupled to circuitry in the same mmWIC. In some examples, antennas and corresponding circuitry are packaged together in a module and each module is associated with a respective group. In some examples, the number of groups is determined based on a time or power budget expected to be available during online DPD training. The groups may be defined such that no antenna elements of the same group are separated by an antenna element of a different group.

In one aspect, a power detector may be coupled to an output of the power amplifier to measure transmit power across frequency. For example, a power droop can be measured for each power amplifier coupled to a representative transmit element across a frequency range including a signal frequency and adjacent channel region. The signal bandwidth in mmW operations may be 500 MHz or more and an adjacent channel region may be 100 MHz at each edge of the signal region (e.g., a total of 700 MHz or more). In some aspects, the power applied to the transmit element is backed off into a linear region when transmit power across frequency is being measured in order to eliminate non-linear effects (e.g., compression) of the power amplifier.

In some aspects, during operation at block 304, the mmW communication device is configured to generate equalizer parameters to equalize (e.g., flatten) the power droop to maintain a linear response over the signal region for each transmit-receive pair. In some examples, the equalizer parameters of each representative transmit element and corresponding receive element for the representative transmit element is measured individually to create a first calibration setting. In some aspects, during a mission mode, the first calibration settings (for all representative transmit elements) are averaged to forward correct based on an average power droop across the different transmit elements. For example, a flat response across a large frequency band cannot be guaranteed over large bandwidths due to the lower impedance of the power amplifier and impedance matching networks.

In one aspect, blocks 302 and 304 are performed offline, or when the mmW communication device is not configured for user operation. For example, blocks 302 and 304 may occur during manufacturing or during an initialization of the mmW communication device. In either case, the identity of the transmit-receive element pairs is stored in a memory (e.g., a non-volatile memory) and is used for online calibration.

At block 306, the mmW communication device is configured to predistort signals based on the first calibration setting. For example, the first calibration setting can be used by a droop equalizer to forward correct power droop for each of the representative transmit elements. In some aspects, the transmit elements may not have a flat frequency response across large bandwidth.

At block 308, the mmW communication device is configured to measure near field signals of the identified transmit-receive element pairs. Block 308 can be triggered based on various events, such as a timer, or based on environmental changes (e.g., temperature changes within the mmW communication device, environmental temperature changes, etc.).

At block 310, the mmW communication device may determine a second calibration setting (e.g., second calibration parameters) to apply to each transmit element in the group of transmit elements based on the measurement of the near field signals using the representative transmit element and corresponding receive element for the representative transmit element. For example, the second calibration parameters may be DPD parameters associated with the measured near field signals. In some aspects, the transmit elements (and/or circuitry associated therewith) can change during online operation. For example, temperature can change a saturation region of a semiconductor device, and the non-linear compression characteristics can change in the saturation region based on memory effects, heat exposure, and so forth.

At block 312, the mmW communication device is configured to predistort transmit signals based on the first calibration setting (e.g., the power droop preequalization) and the second calibration settings.

In some aspects, as the conditions of the mmW communication device change (e.g., temperature, age, etc.), the online calibration parameters can configure the mmW communication device at runtime to account for different effects in different groups at runtime as opposed to using a static configuration.

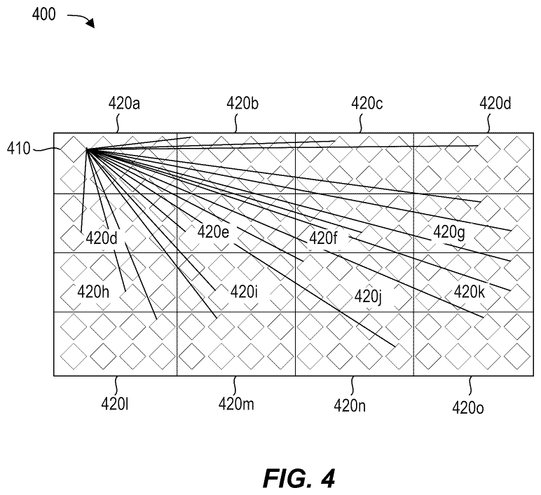

FIG. 4 is a conceptual diagram of a large array of antenna elements and identifying different transmit-receive groups and a loopback associated with a representative transmit element in accordance with some aspects of the disclosure. In particular, FIG. 4 is an illustration of a plan view of a large array 400 of antenna elements that are coupled to corresponding mmWICs. For example, an antenna element 410 of the antenna elements may be used to perform a calibration as further described below. In some aspects, the antenna elements are located on a top surface (or in one or more upper layers) and multiple mmWICs can be disposed on a back (e.g., bottom) surface (not shown). The antenna elements may be disposed on a common substrate, or each group may be disposed on a respective substrate. In other examples, some groups share a substrate while other groups have separate substrates. FIG. 4 illustrates a signal path from the antenna element 410 to multiple receive elements such that a transmit and receive pair can be identified to form a loopback from a transmit signal path to a receive signal path.

In some aspects, an online self-DPD training may be used based on a loopback signal to change the DPD parameters based on temperature and device aging. In some aspects, an online operation refers to the activities and functionalities of a device (e.g., a large array of elements of a mmW base station) when connected to a network and operational for end users. Non-limiting examples of online operations of a mmW base station include controlling, monitoring, and managing the base station while it is configured to serve users and handle traffic. In some aspects, the mmW communication device may perform loopback testing of a particular transmit element and corresponding receive element for the representative transmit element and adjust parameters associated with DPD, which may result in an increased Pbump (e.g., power at a bump or other means that interfaces a mmWIC or other chip with an antenna) during online operation and allow the mmW communication device to adapt to temperature and aging over a wide bandwidth.

In some aspects, performing online DPD training for each element would consume a massive amount of time. Performing measurements at different combinations of 128 different transmit and receive elements is exponential and would result on the order of N transmissions and N^{N-1} calculations, with N being the number of transmit and receive elements. In some aspects, the large array 400 is divided into different groups based on physical location of the transmit and receive elements. For example, the groups may be defined such that no antenna elements of another group are between antenna elements of a given group. The shape of the groups may be the same, or may vary within the array. For example, each of the groups is illustrated in FIG. 4 as being rectangular and having 4×2 elements, but the groups may be square or linear, have a diamond shape, include more or less elements, etc. In some aspects, the groups are defined by the mmWIC to which they are coupled. For example, each group may be coupled to a respective mmWIC, with the group including all transmit and receive elements which are coupled to the respective mmWIC. In other examples, the transmit and receive elements which are coupled to a common mmWIC are divided into multiple (for example, two) groups (e.g., 420a and 420e are coupled to the same mmWIC, but are different groups). In some aspects, the mmWICs can respond differently based on process corners (e.g., fast process, slow process, etc.) during semiconductor manufacturing. In addition, the physical location of the mmWICs also can affect performance and aging because temperature and other effects (such as neighboring mmWICs) can be affected based on physical location. As an example, a mmWIC in the center of the large array 400 may be exposed to more heat than a mmWIC at a corner of the large array 400.

In one example, the large array 400 may be physically and/or conceptually divided into 16 different groups, or groups 420a to 420p. A single transmit element is selected from each of the groups 420a to 420p as a training element. For example, a processor (e.g., the data processor 210) selects the antenna element 410 in group 420a as a training element for illustrative purposes. In some aspects, the transmit element is selected based on average performance to tradeoff between performance and complexity.

For each selected transmit element, a corresponding receive element may be identified to capture a near field signal using an over the air loopback during an initial calibration and online calibration. For example, the mmWIC associated with antenna element 410 in group 420a may transmit a signal and other receive elements in each of the groups 420a to 420p (e.g., every receive element except the receive element associated with the antenna element 410) may receive the signal in the near field. In some aspects, offline self-calibration is configured to find the receive element that best characterizes the transmit performance of the transmit element. For each of the received near field signals (e.g., 127 near field signals), a received near field signal is provided to an error correction block (e.g., in the processor) to correct for error and remove effects due to the channel. After correcting the received near field signal, a reconstructed waveform corresponding to the transmitted signal is generated based on the corrected near field signal and an existing or initial set of DPD parameters. An error may be computed between the reconstructed waveform and the transmitted near field signal. For example, a normalized minimum square error (NMSE) may be calculated for each receive element.

A respective receive element to be associated with the transmit element is selected based the computed error (e.g., an NMSE measurement). In some aspects, a low NMSE error is correlated with good EVM performance and indirectly identifies an transmit-receive element match. In some cases, an NMSE is indicative of power droop across the frequency band. For example, the transmit-receive element and a corresponding mmWIC may need to support 500 MHz of bandwidth for signal transmission and another 200 MHz for ACLR to prevent interfering with adjacent channels. The receive element with the lowest computed error may be selected in some examples, or any receive element having an error below a threshold may be selected in other examples.

In this example, 16 different transmit elements (one within each group of groups 420a to 420p) are each paired with a respective receive element. In some aspects, because a medium transmit element was selected in a large array (e.g., 128-element array), the transmit signals are equivalent to an average and the total combined signal from all elements in the array may be approximately equivalent to a signal from a medium transmit element. In addition, each signal path may be impaired due to various parasitic and non-linear effects. For example, a signal path can be impaired due to the non-linearity of the power amplifier, thermal noise, phase noise, memory effect, etc. The impairments maybe be averaged out and have insignificant effects in a large array and the total combined signal from all elements in the array may be roughly equivalent to a signal from a medium transmit element. In some aspects, medium transmit elements are selected as the representative transmit element of a group to reduce complexity without significantly affecting performance.

In some aspects, using a medium transmit element within a group (or subset) of transmit elements that is paired with an optimal receive element to perform DPD calibration may provide close to optimal performance but with significantly reduced calibration time. In the example shown in FIG. 4, 128 different transmit and receive elements are divided into sixteen groups of transmit elements and calibration parameters for each group is measured. The combined performance of the sixteen groups of transmit elements may substantially approximate ideal performance based on individual calibration of each transmit element and corresponding receive element for that transmit element (e.g., 128 different calibration parameters).

In some aspects, FIG. 4 discloses selecting a transmit element from a plurality of TX elements and selecting a receive element for each selected TX element. In a sub-optimal transmit-receive element pair, the memory effect associated with AM-AM is larger and the frequency domain droop is large. In a static calibration, the DPD parameters may be overly aggressive based on measurements in a static environment that does not account for effects during online operation.

By selecting a medium transmit element with a receive element based on at least one measurement (e.g., an NMSE measurement), the DPD is trained on an average transmit element associated with that particular group and may provide performance close to the ideal match. For example, 16 elements (e.g., one transmit element for each mmwIC) may be sufficient. In some aspects, the number of elements selected addresses scenarios in which the mmWICs are in different manufacturing process corners (e.g., fast, slow, high voltage, low voltage, etc.).

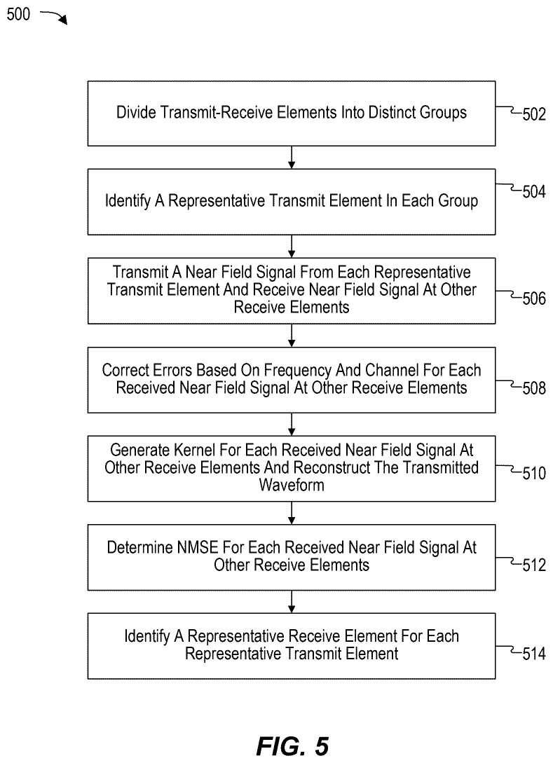

FIG. 5 is a flow diagram illustrating a method 500 for selecting a receive element for a representative transmit element in accordance with aspects of the present disclosure. In some aspects, the operations of the method 500 can be performed by control circuitry and elements of a mmW communication device as described herein. In some aspects, the operations of the method 500 can be implemented as instructions (e.g., reference numeral 299) stored in a computer readable storage medium (e.g., memory 298) that, when executed by processing or control circuitry of a device (e.g., processor 296), cause a wireless device such as a large array (or component thereof) to perform the described operations. The blocks in the method 500 can be performed in or out of the order shown, and in some aspects, can be performed at least in part in parallel.

At block 502, the mmW communication device may divide the transmit elements into distinct groups. In some cases, the transmit elements may be preconfigured, such as based on a physical arrangement similar to those shown in FIG. 4. In aspects, the groups may be configured on different qualities, such as process corners, a pseudo-random selection, and so forth.

At block 504, the mmW communication device may identify a representative transmit element for each group. For example, the mmW communication device may identify a transmit element of each group that has average performance for at least one parameter.

At block 506, the mmW communication device is configured to transmit a reference signal from each representative transmit element and receive the signal in the near field at each of the other receive elements. For example, in a 128-element array, a single transmit element is configured to transmit the signal and the remaining 127 receive elements not associated with the transmit element may receive the signal in the near field.

At block 508, for each of the received near field signals (e.g., the 127 received near field signals), the mmW communication device is configured to correct errors in the receive near field signal based on the frequency and the channel.

At block 510, the mmW communication device is configured to reconstruct an evaluation near field signal for each received near field signal. In one aspect, the mmW communication device is configured to use a kernel (e.g., a channel impulse response) and the corresponding received near field signal to digitally reconstruct the evaluation near field signal.

At block 512, the mmW communication device is configured to determine an error based on the received near field signal and reference near field signal. In one example, an NMSE is calculated based on the reference near field signal and the evaluation near field signal. In some aspects, the NMSE may be indicative of good EVM performance.

At block 514, the mmW communication device is configured to identify a representative receive element for each representative transmit element based on an NMSE. The likelihood of good NMSE performance is correlated to EVM performance. For example, a low NMSE is generally a good indicator of EVM performance, but a high NMSE may indicate bad EVM performance. For example, at block 514, the mmW communication device identifies a corresponding receive element for each representative transmit element that represents each corresponding group of transmit elements (e.g., a representative transmit-receive element pair). Examples are provided herein of identifying a single receive element for each representative transmit element. In other examples, multiple receive elements may be identified for one or more (e.g., all of) the representative transmit elements. In some examples, the method 500 is performed offline.

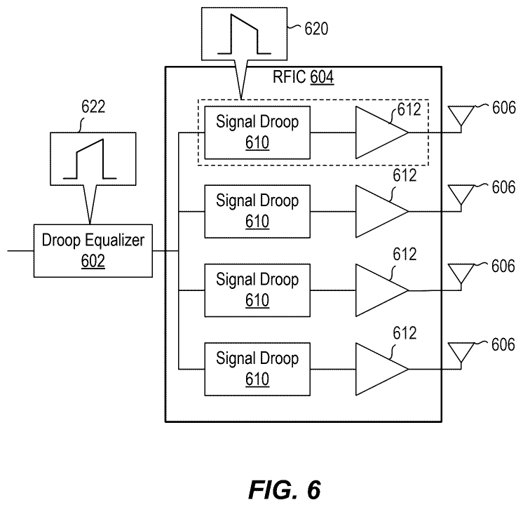

FIG. 6 is a block diagram 600 of an mmW communication device configured to forward correct power droop based on a representative transmit element and corresponding receive element for the representative transmit element in accordance with some aspects of the disclosure.

In some aspects, once the representative transmit element and corresponding receive element for the representative transmit element is identified, during an offline calibration a power droop of the transmit element may be measured. A flat frequency response across a large frequency band is often not possible over large bandwidths due to the lower impedance of the power amplifier. A power droop may be detected over the frequency and may be forward corrected based on predistorting a transmit signal. For example, an IF signal may be corrected in mission mode such that all transmit elements receive the corrected signal. In other examples, an RF signal for a respective path is corrected (e.g., during calibration) such that only that path is affected by the correction. In some examples, an IF signal may be corrected when only one signal path is enabled such that correction can be controlled for respective signal paths without requiring correction circuitry to operate at RF. In one aspect, an offline power calibration may be performed to generate forward correction parameters of the transmit signal to improve power droop. For example, a power detector may be coupled to an output node of the transmit element and a power measurement may be performed to measure the power droop of a reference signal across the signal region and an adjacent channel region. In a non-limiting example, a mmW communication device transmit element may be configured to transmit in a 500 MHz bandwidth, and a 100 MHz region at peripheral edges of the signal region (e.g., the 500 MHz) may also be measured.

In some aspects, during the offline calibration, the mmW communication device (or another calibration system in manufacturing) may bias the transmit element in a linear region. For example, the transmit element is backed off to prevent non-linear power amplifier effects (e.g., compression) to measure the power droop. In some aspects, the power detector may measure the power of an ideal reference signal that characterizes a transmission signal of the mmW communication device. For example, an ideal reference signal may include 5 different 90 MHz bands with a 10 MHz guard band between each 90 MHz band. After measurement of the power droop of each representative transmit element, the mmW communication device or another calibration system may generate calibration parameters (e.g., forward calibration parameters 622) to forward correct the signal during online operation.

The block diagram 600 illustrates online operation and forward correction of power droop. In one aspect, the mmW communication device may include a droop equalizer 602 and an mmWIC 604. In some aspects, the mmW communication device provides an IF signal to the droop equalizer 602 to forward correct based on an average power droop of the representative transmit elements during mission mode (e.g., during online operation). For example, the droop equalizer 602 may apply the forward calibration parameters 622 to forward correct the IF signal and then provide the forward corrected IF signal to the mmWIC 604. The mmWIC 604 includes transmit elements 612 for transmission via different antenna elements 606. Each transmit element 612 also includes a signal droop 610 that impairs the signal path of each channel. For example, the signal droop 610 corresponds to active and passive parasitics of the transmit element 612 and the antenna element 606 of each signal path.

In some aspects, the transmit elements 612 and its corresponding channel is forward corrected based on the signal droop 610. For example, the droop equalizer 602 predistorts a signal based on the signal droop 610 of the transmit element 612 and the antenna element 606. The droop equalizer 602 may also equalize channel characteristics from the antenna element 606 to the recipient. For example, power droop of the transmit elements 612 is based on bandwidth, impedance matching circuitry, non-linear response of the transmit elements 612 over frequency, and other non-linear effects.

The droop equalizer 602 is configured to apply the forward calibration parameters 622 based on the power droop measurements during offline calibration. In this example, a power droop of each representative transmit element is measured to generate the forward calibration parameters 622. In some aspects, the forward calibration parameters 622 may be stored during offline calibration and applied to the (IF) signal by the droop equalizer 602 during online operation. The forward correction of the power droop may improve the EVM performance of each transmit element by 2-3 dB.

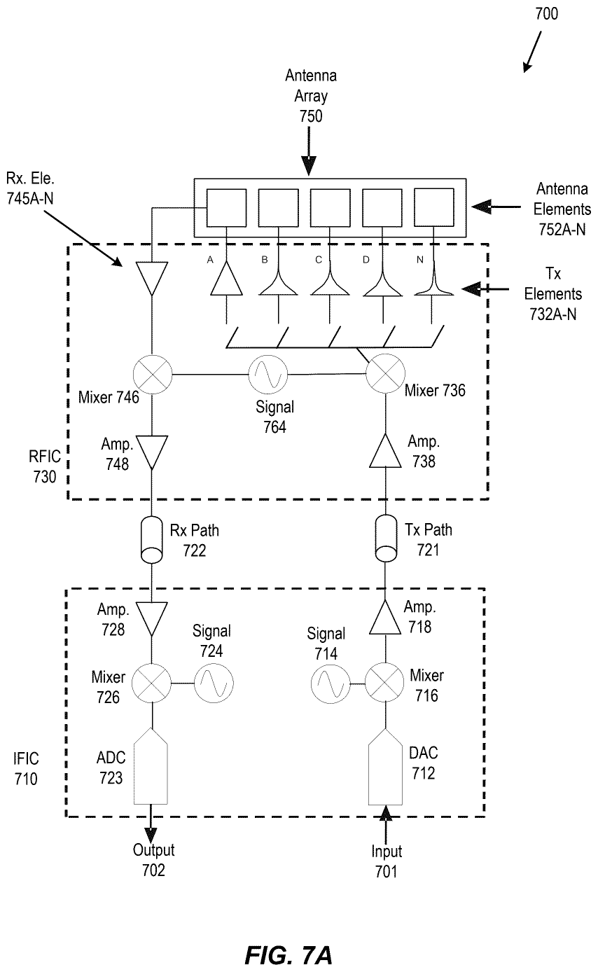

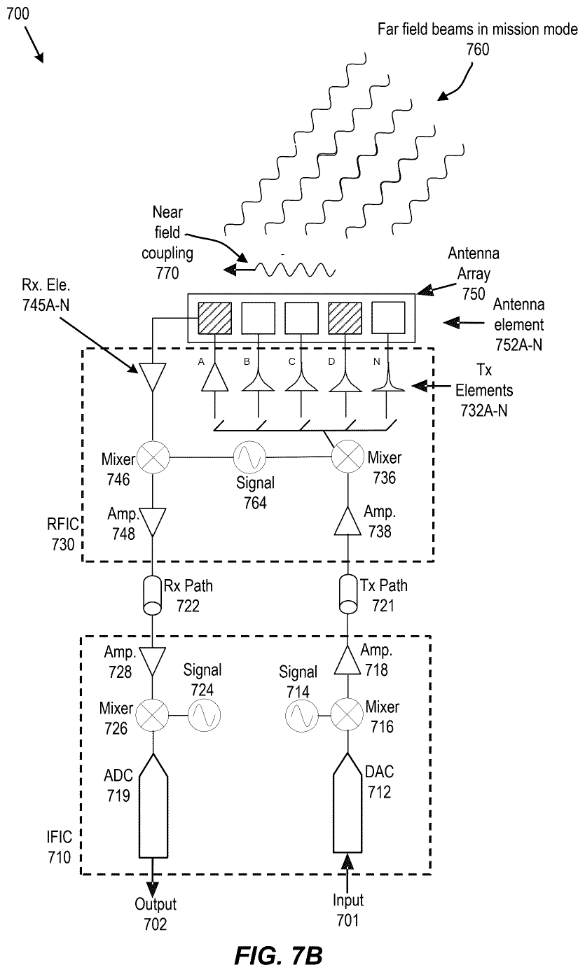

FIG. 7A illustrates aspects of an mmW communication device 700 involved with predistortion calibration in accordance with aspects described herein. In some aspects, the predistortion calibration occurs during online operation at each representative transmit element and corresponding receive element for the representative transmit element, and the predistortion calibration is applied to each transmit element. For example, in a 128-element array, sixteen different groups of eight transmit elements (e.g., as shown in FIG. 4) may be configured and sixteen representative transmit elements and corresponding receive elements are selected during offline calibration. During online operation, the sixteen representative transmit elements and corresponding receive elements may be calibrated during online operation to account for runtime effects (e.g., aging, temperature, etc.).

The calibration may occur based on various triggers, such as an internal ambient temperature (e.g., detected by a temperature sensor) rising by a particular threshold (e.g., 5° C.) or above particular thresholds (e.g., 70° C., 80° C.). The calibration may occur at different lifespan intervals (e.g., every day at a specific time). The calibration may also be triggered based on external environmental effects, such as an external ambient temperature rising above a particular threshold.

The mmW communication device includes an antenna array 750 (e.g., which may be similar to the antenna array 248 and/or the array included in the mmW RF module 1000 of FIGS. 10A-D), an mmWIC 730, and an intermediate frequency integrated circuitry (IFIC) 710. The IFIC 710 is communicatively coupled to other circuitry (e.g., the data processor 210, for example a modem) to receive digital data at an input 701 of the DAC 712 (which may be an example of the DAC 214) for transmission and to provide received data via the analog-to-digital converter (ADC) 723 (which may be an example of the ADC 216). Digital data received at the DAC 712 is upconverted to an intermediate frequency using signal 714 (e.g., an IF mixing signal) with a mixer 716 (which may be an example of the upconverter 240) and then amplified using amplifier 718 for communication to the mmWIC 730 via the transmission path 721 (e.g., a cable, routing, etc.). At the mmWIC 730, the intermediate frequency transmission signal is received at the amplifier 738, amplified, and then upconverted to the communication frequency using the signal 764 and the mixer 736 (which may be an example of the mixer 276). Different TX elements 732A-N provide the mmW frequency transmission signal to respective antennas in the antenna array 750. The use of A-N labeling, without illustrating all letters between A and N, is meant to represent the possible inclusion of an arbitrary number of elements. In some aspects, 8 TX elements 732 may be present. In other aspects, the TX elements 732 may include any number of elements (e.g., any positive integer number) suitable for a given design. In some aspects, each of the TX elements 732A-N may include a phase shifter, a power amplifier, and a connection to a different element of the antenna elements 752A-N, and may be an example of a portion of a phased array element 287.

In FIG. 7A, a representative receive path is shown with a single RX element used to represent RX elements 745A-N. Each of the antenna elements 752A-N will have an associated RX element of the RX elements 745A-N (e.g., amplification circuitry, which may be included in a phased array element 287, outputs of which may be combined prior to being input to mixer 746) set to receive a wireless signal. FIG. 7A additionally illustrates mixer 746 (which may be an example of the mixer 286) used with the signal 764 to downconvert the received signal, amplifier 748, RX path 722, and amplifier 728 to provide the received signal to the IFIC 710. At the IFIC 710, the intermediate signal (e.g., downconverted from the communication frequency by the mixer 746) is downconverted by mixer 726 (which may be an example of the downconverter 260) and the signal 724 to a baseband frequency, and then converted to a digital signal by the ADC 723. The digital signal may be provided at output 702 to additional portions of a device. In other examples, direct conversion may be implemented to downconvert frequency directly to the baseband frequency. The signal 764 may be the same signal or provided by the same LO to both the receive and transmit functions in the mmWIC 730. In other examples, different signals and/or different LOs are used to support the transmit and receive functions in the mmWIC 730. Further, different signals (714, 724) and/or different LOs may be used to support the transmit and receive functions in the IFIC 710. In other examples, the same signal used or signals provided by the same LO are used for both the receive and transmit functions in the IFIC 730.

As indicated above, the antenna loading of the different TX elements 752A-N may have non-linearities as a function of the individual antenna loading. As described in detail below, use of a medium gain TX element combined with RX element selection may identify a signal path for near field mutual coupling that provides loopback data with performance to replace FBRX hardware for DPD training. FIG. 7A illustrates multiple TX elements 732A-N with a representative RX element representing the RX elements 745A-N for ease of illustration, multiple RX elements are present. As shown, the different TX elements 732A-N are illustrated differently, with the combinations of elements making up each TX element 732 (e.g., separate phase shifters, power amplifiers, connectors, etc., for each of the TX elements 732A, 732B, 732C, 732D, 732N, etc.) having different associated antenna loading values. TX element 732A is illustrated as being different than TX element 732N, which are both different than TX elements 732B, 732C, and 732D. For example, the illustrated width of the TX elements 732 may be representative of an amount of loading or gain of that TX element. In some aspects, certain loading values, (e.g., as illustrated by the outlier representations of the TX element 732A and the TX element 732N) may fail to meet target criteria (e.g., provide performance data that exceed target values as illustrated by the performance data 420 exceeding the target values), while intermediate or moderate loading values, as represented by the TX elements 732B-D, meet target criteria (e.g., provide performance data that is less than a target values).

During calibration, a given combination of TX and RX paths may be tested to identify loading values for different paths that meet target values, or that provide preferred performance as measured against provided performance criteria as described herein.

Further, as described above, each antenna element may operate with one or more polarizations (e.g., to transmit or receive wireless signals associated with a given polarization, or with multiple (e.g., orthogonal) polarizations). In some aspects, transmission may occur on a first polarization, and reception may occur on a second polarization different from the first polarization. In other aspects, transmission and reception may occur on the same polarization.

FIG. 7B illustrates aspects of the mmW communication device 700 involved with predistortion calibration in accordance with aspects described herein. FIG. 7B includes the same details of the mmW communication device 700 in the IFIC 710 and the MMWIC 730, with the addition of operational details of wireless signals operating over the air. In particular, during communications with another device, far field beams in mission mode 760 will be transmitted to and from the antenna array 750 using the mmW frequencies. The digital predistortion calibration and the training path operations described herein, however, relate to loopback over the air communications and measurements using near field coupling 770 between different elements 752A-N of the antenna array 750.

As indicated above, each antenna element 752A-N may have associated TX elements 732A-N and RX elements 745A-N. For simplicity, only antenna element 752A is shown as associated with both an RX element and TX element. Each of the antenna elements 752A-N, however, may have associated TX elements and RX elements (e.g., pairs of TX elements 732A-N and RX elements 745A-N). To effectuate near field coupling 770, an antenna element is selected for transmission, with the associated TX element, and a different antenna element of the antenna array 750 is selected with the associated RX element. The selection is performed by taking measurements for different combinations of TX and RX paths (e.g., having different associated antenna loading values). In this example, the antenna element 752D is selected for transmission and antenna element 752A is selected for reception, as indicated by shading of the antenna elements in the figure. Because of the physical proximity of the antenna element 752D and the antenna element 752A, the amplification of the selected RX element of RX elements 745A-N may be set to a very low level and prevent far field beams (e.g., from other devices or other noise signals outside the system) that are incident upon the antenna array 750 during calibration measurements from having a significant impact on the measurements. The RX gain may then be adjusted based on the TX signal from the near field coupling 770.

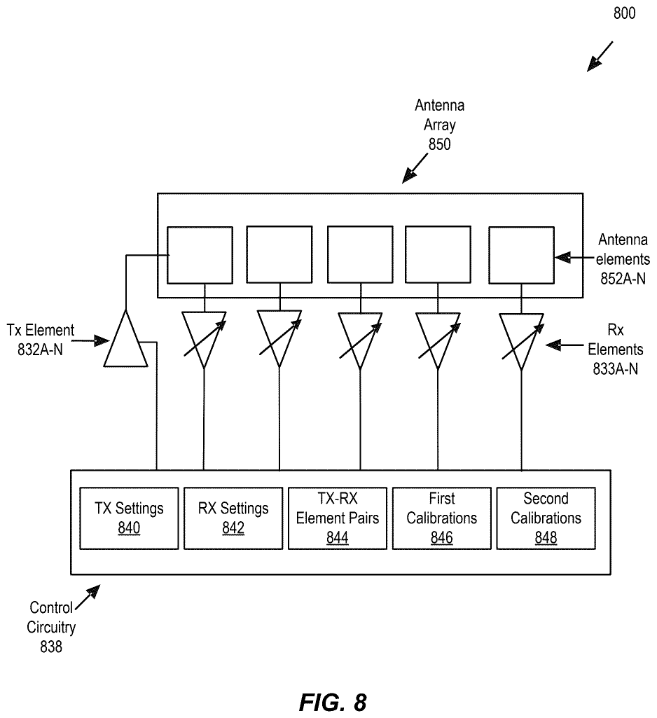

The near field coupling 770 is a function of a distance between a selected TX element and a selected RX element, operating frequency, antenna design, and housing and packaging structure for a device. The path searching to determine the mmW digital predistortion calibration determines an RX gain state that gives a selected RX signal to noise ratio (SNR) based on a mutual coupling level of a selected RX element and TX element. The combination of the selected RX element from the path searching (e.g., as illustrated by the example of FIG. 8) provides a gain state and an operating point for a loopback path used in digital predistortion calibration.

FIG. 8 illustrates aspects of a mmW communication device 800 including transmit correction and a predistortion calibration in accordance with some aspects of the disclosure. The mmW communication device 800 is similar to the mmW communication device 700 but illustrates a plurality of transmit and receive elements. As mentioned above, FIGS. 7A and 7B only show a single receive element representing the receive element, and the mmW communication device (e.g., the mmW communication device 700) may include multiple receive elements 833A-N. The RX elements are illustrated as a single element in FIGS. 7A and 7B may be similar to the RX elements 833A-N with a single RX element (for each representative transmit element) selected for operation based on calibration as described herein.

Similarly, FIGS. 7A and 7B illustrate TX elements 732A-N while FIG. 8 illustrates a single TX element to represent TX elements 732A-N, (e.g., similar to the TX elements 732A-N described above). The mmW communication device 800 includes an associated TX element 832A-N for each of the antenna elements 852A-N, which multiple TX elements are omitted from the figure for simplicity and to emphasize the operations of path searching for mmW digital predistortion calibration in accordance with aspects herein.

The mmW communication device 800 also includes control circuitry 838 (e.g., control circuitry of a modem or a data processor such as the data processor 210). The control circuitry 838 includes a memory and control settings to select test states and store measurement data for path searching for mmW digital predistortion calibration in accordance with aspects herein. For example, the mmW communication device 800 includes transmit settings 840, receive settings 842, transmit-receive element pairs 844, and first calibration parameters 846, and second calibration parameters 848.

In some aspect, the transmit settings 840 include gain settings for each transmit element and the receive settings 842 include gain settings for each receive element. The transmit-receive element pairs 844 (e.g., a representative transmit element and corresponding receive element for that transmit element) represent each group of transmit elements (e.g., the sixteen groups of transmit elements). For example, the control circuitry 838 may control the mmW communication device 800 to perform the calibration of the representative transmit element and the corresponding receive element during online operation of the mmW communication device 800. For example, the mmW communication device 800 may perform a near field signal measurement of each representative transmit element and corresponding receive element for the representative transmit element pair and determine at least one corresponding predistortion coefficient to correct transmission and reception signals based on operation. For example, power amplifier characteristic (e.g., gain, saturated power, etc.) changes over temperature and the online calibration of the representative transmit element and corresponding receive element for the representative transmit element changes the predistortion coefficients during deployment. The online calibration of the transmit and receive elements may be stored as the first calibration parameters 846.

In some aspects, the mmW communication device 800 may be partially calibrated during offline operation and forward calibration parameters may be included in the second calibration parameters 848 to correct for power droop based on intrinsic power amplifier properties. For example, offline operation may be during manufacturing, or may be a calibration that is performed during a maintenance window. The first calibration parameters 846 and/or the second calibration parameters 848 may also include other information related to other information, such as biasing information, lookup tables, and so forth.

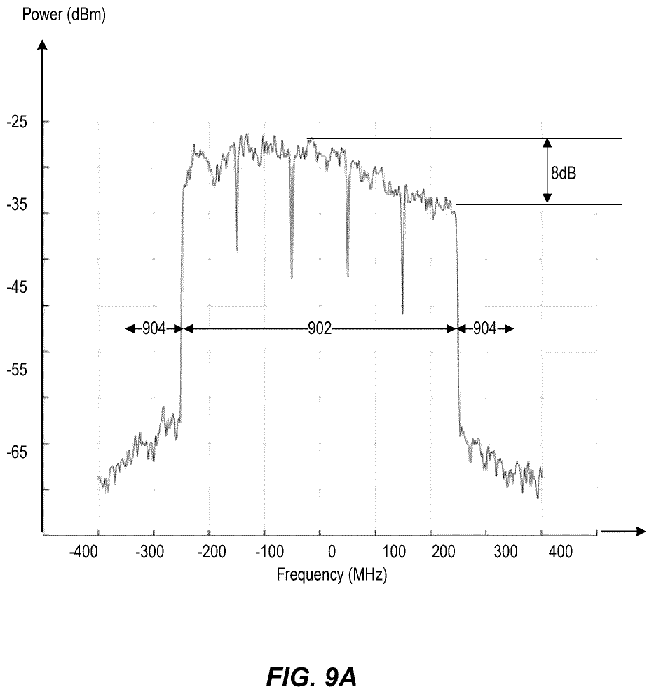

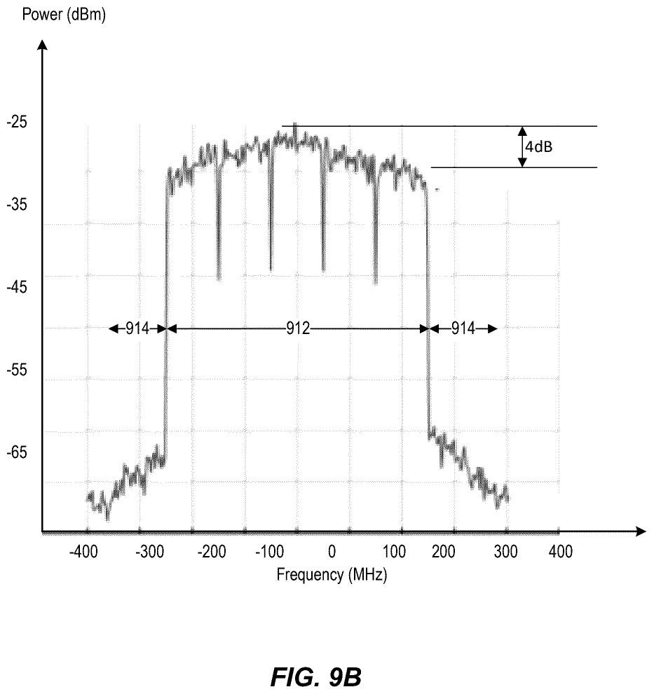

FIG. 9A illustrates a power droop of a mmW communication device using static calibrations with an OTA loopback capture with a transmit element. As shown in FIG. 9A, a signal region 902 associated with an mmW reference signal is illustrated with corresponding adjacent channel regions 904. In some cases, the adjacent channel regions may be referred to as ACLR regions based on affecting neighboring signal regions. FIG. 9A illustrates an 8 dB droop across the signal region, which affects the biasing of the power amplifier. For example, the mmW communication device may need to bias the power amplifier based on the 8 dB droop such that a lowest frequency response (e.g., at +250 MHz) provides a minimum power transmission (e.g., −35 dBm). As a result, the mmW communication device creates more memory effect, non-linearities, saturation and consumes high power based on the droop.

FIG. 9B illustrates a power droop of a mmW communication device using offline and online calibrations with an OTA loopback capture with the same transmit element in FIG. 9A. As shown in FIG. 9B, a signal region 912 associated with an mmW reference signal is illustrated with corresponding adjacent channel regions 914. FIG. 9B illustrates a 4 dB droop across the signal region 912, which may affect the biasing of the power amplifier. As such, the power amplifier in FIG. 9B may be biased with 4 dB lower, thereby reducing energy consumption. In addition, the non-linear effects such as saturation, non-linearities, have fewer effects on the semiconductor materials. The representative transmit element and corresponding receive element for the representative transmit element in FIG. 9A has a higher OTA droop than the representative transmit element and corresponding receive element for the representative transmit element in FIG. 9B, which may cause the receive element in FIG. 9B to be selected during NMSE screening during receive element selection.

In some cases, the mmW communication device in FIG. 9B may be biased at a higher power. For example, a 128-element array using the disclosed calibration techniques may be biased at 12 dBm/500 MHz, and a conventional 128-element array may be biased at 8.5 dBm/500 MHz. To achieve the same EIRP with a static calibration, the mmW communication device would require 192 transmit elements, increasing the hardware cost by at least 33%. In this aspect, the mmW communication device may require fewer transmit/receive element pairs to achieve a higher EIRP. In addition, the adjacent channel regions improve 2-3 dB over the mmW communication device in FIG. 9A, reducing interference effects with adjacent transmission and other neighboring devices.

In addition, the power droop in FIG. 9B is more symmetrical about the center frequency. Symmetry in RF performance leads to additional benefits such as lower loss, improved non-linear performance, and so forth due to skin effect and other passive effects.

FIGS. 10A, 10B, 10C and 10D are block diagrams illustrating a millimeter wave RF module in accordance with exemplary aspects of the disclosure. FIGS. 10A, 10B and 10C are block diagrams collectively illustrating an exemplary aspect of a millimeter wave (mmW) RF module that may implement path searching for mmW digital predistortion calibration in accordance with aspects described herein.

FIG. 10A shows a side view of a RF module 1000. The RF module 1000 may be an example of any mmW communication device or a mmW module of a communication device used to implement DPD path calibration as described herein for mmW communications. In an exemplary aspect, the RF module 1000 may comprise a 1×8 phased array fabricated on a substrate 1003. In an exemplary aspect, the RF module 1000 may comprise a mmWIC 1010 (which may be an example of the mmWIC 530), a power management IC (PMIC) 1015, a connector 1017 and a plurality of antennas 1021, 1022, 1023, 1024, 1025, 1026, 1027 and 1028 fabricated on a substrate 1003 (which may be examples of the antenna elements 552 in the antenna array 550). Such phased array and antenna elements may be used to implement TX and RX elements of a mmW device, and control circuitry integrated with the mmW RF module 1000 or coupled to the mmW RF module 1000 may be used to implement path searching for mmW digital predistortion calibration as described herein.

FIG. 10B is a top perspective view of the RF module 1000 showing the mmWIC 1010, a PMIC 1015, a connector 1017 and a plurality of antennas 1021, 1022, 1023, 1024, 1025, 1026, 1027 and 1028 on the substrate 1003.

FIG. 10C is a bottom perspective view of the RF module 1000 showing the antennas 1021, 1022, 1023, 1024, 1025, 1026, 1027 and 1028 on the substrate 1003.

FIG. 10D shows an alternative aspect of a millimeter wave (mmW) RF module 1050. The RF module 1050 may be similar to the RF module 1000 shown in FIG. 10A, but is arranged as a 1×6 array. In an exemplary aspect, the RF module 1050 may comprise a 1×6 phased array fabricated on a substrate 1053.

In an exemplary aspect, the RF module 1050 may comprise a plurality of antennas 1071, 1072, 1073, 1074, 1075 and 1076 (which may be examples of the antenna elements 552 in the antenna array 550) fabricated on the substrate 1053. Those of skill in the art will understand that an RF module may be implemented which includes a greater or fewer number of antennas, and/or that includes antennas in a configuration other than a linear array. For example, in view of the description above, either of the mmW modules 1000, 1050 may be configured with a two dimensional array of antennas, for example in a 2×4 or 2×3 arrangement.

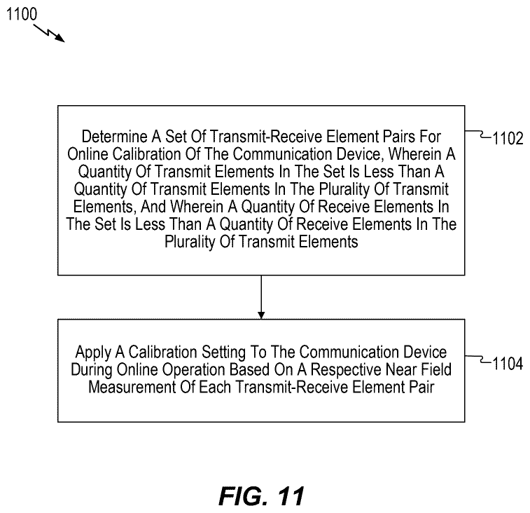

FIG. 11 is a flow diagram describing an example of the operation of a method 1100 for operation of a device including search and selection operations for mmW digital predistortion calibration in accordance with aspects described herein. In some aspects, the operations of the method 1100 may be performed by control circuitry and elements of a mmW communication device as described herein. In some aspects, the operations of the method 1100 may be implemented as instructions stored in a computer readable storage medium that, when executed by processing or control circuitry of a device, cause the mmW communication device to perform the described operations. The blocks in the method 1100 may be performed in or out of the order shown, and in some aspects, may be performed at least in part in parallel.

At block 1102, the mmW communication device (e.g., or a component thereof) may determine a set of transmit-receive element pairs for online calibration of the communication device. In one aspect, the wireless communication device includes a plurality of transmit elements and a plurality of receive elements. In some cases, a quantity of transmit elements in the set is less than a quantity of transmit elements in the plurality of transmit elements, and a quantity of receive elements in the set is less than a quantity of receive elements in the plurality of transmit elements. The plurality of transmit elements and the plurality of receive elements are divided into different groups, for example based on a physical arrangement and/or a relation to one or more ICs. In some aspects, each group of the different groups is associated with a respective transmit-receive element pair. The transmit element of a group is included within the group, and a corresponding receive element be any other receive element within the mmW communication device. The pairs may be determined offline for later use in online calibration. The mmW communication device (or component thereof, such as the data processor 210) may be configured to determine the set autonomously, or a user or technician may instruct the device during the determination. In some examples, the determination in block 1102 comprises accessing previously stored transmit-receive element pairs.

In one aspect, the set of transmit-receive element pairs is stored in a non-volatile memory during an offline calibration. For example, to determine the representative transmit-receive element pair, the mmW communication device is configured to select a representative transmit element and corresponding receive element for the representative transmit element from a group of transmit elements. The representative transmit element may be selected based on average performance within the group. For example, 16 DPD measurements may be performed, and the transmit element having the performance closest to average (or the median transmit element, in some examples) is selected as the representative transmit element. Other variations are possible, such as selecting an average transmit element in connection with the position of the transmit element within the group or proximity to other transmit elements. The mmW communication device may then transmit a signal from the representative transmit element and select a representative receive element for the representative transmit element and corresponding receive element for the representative transmit element based on a received near field signal received by other receive elements excluding the representative receive element associated with the representative transmit element. In one aspect, to select the representative receive element, the mmW communication device may be configured to correct a frequency error of each near field signal received by the other receive elements, reconstruct a signal from each received near field signal received by the other receive elements, determine an error based the reconstructed signal and the transmitted signal, and select the representative receive element based on the error.

In some aspects, the mmW communication device (e.g., or a component thereof) may optionally perform a respective power measurement for each transmit element associated with a representative transmit element and corresponding receive element for the representative transmit element using a reference signal. In one aspect, to perform the power measurement, the mmW communication device may measure a power droop of the reference signal at an output node of a representative transmit element. In some aspects, a frequency associated with the power droop includes a signal region and an adjacent channel region. In some aspects, the representative transmit element of the representative transmit-receive element pair is biased in a linear region during transmission of the reference signal. The power measurement and/or determination of the power droop may be performed offline and/or online.

In some aspects, the mmW communication device (e.g., or a component thereof) may optionally determine a first calibration setting based on the respective power measurement of each transmit element. In some aspects, the mmW communication device is configured to generate equalizer parameters to equalize (e.g., flatten) the power droop to maintain a linear response over the signal region for each transmit-receive pair based on the respective power measurements. In some examples, the equalizer parameters for each transmit-receive element pair and/or the power droop measurements for each transmit-receive element pair are combined (e.g., averaged) to create the first calibration setting such that the first calibration setting can be used during a mission mode. For example, during mission mode (e.g., transmission of data/communication signals), multiple transmit elements may be concurrently active and cannot be individually corrected. The mmW communication device may determine the first calibration setting based on the combination of individual power droop measurements to handle an average loss during mission mode.

In some cases, the mmW communication device (e.g., or a component thereof) may optionally apply the first calibration setting to the communication device. For example, during mission mode, the mmW communication device may apply the first calibration setting to forward correct an average power droop loss since multiple transmit elements can be concurrently transmitting.

In some aspects, during online operation, the mmW communication device (e.g., or a component thereof) may determine second calibration settings. For example, to determine the second calibration setting, the mmW communication device may determine respective predistortion (e.g., DPD) coefficients for each representative transmit element and corresponding receive element for the representative transmit element based on an online near field measurement of a reference signal transmitted and received by each representative transmit-receive element pair. For example, in the case of a 128-element array, the elements may be divided into groups of 8 and 16 different (sets of) second calibration settings determined using the online processes. As described in detail above, the representative transmit element may represent an average transmit element associated with a group that shares similar location features and experiences similar physical effects such as temperature, and/or may be coupled to a common IC. The second calibration settings represent runtime changes that are experienced by the group and allow a real-time correcting of the transmit elements, for example based on a single calibration. During the online determination of the DPD settings, the power droop/equalizer parameters (e.g., first calibration setting) may be individually applied to each respective transmit-receive element pair. For example, each respective transmit element may be configured to transmit a reference signal and the corresponding receive element may be configured to receive a near field signal such that the mmW communication device can determine a set of DPD coefficients for the respective transmit-receive element pair in series (e.g., one transmit-receive element pair at a time, such that multiple transmit-receive element pairs are not being calibrated concurrently). As that only one pair may be operational at a time, the power droop/equalizer settings determined for that specific pair may be individually applied during this online calibration instead of using the averaged power droop/equalizer settings (which may be applied during mission mode when multiple elements are transmitting concurrently).

At block 1104, the mmW communication device (e.g., or a component thereof) applies a calibration setting (e.g., the second calibration setting) to the communication device during online operation (e.g., mission mode) based on the respective near field measurement of each representative transmit element and corresponding receive element for the representative transmit element during the online operation. In some aspects, the calibration setting (e.g., the second calibration setting) is based on a respective (set of) predistortion coefficient(s) for each transmit-receive element pair. In some examples, the calibration setting (e.g., the second calibration setting) is determined by averaging the DPD settings determined for the respective transmit-receive element pairs. For example, referring to the example described above in which there are 16 groups, 16 sets of DPD coefficients may be generated during online operation of the mmW communication device. These 16 sets of DPD coefficients may be mathematically averaged to create one set of one or more second calibration settings. At block 1108, signals may concurrently be transmitted from multiple transmit elements in the mmW communication device using the averaged DPD coefficients (e.g., second calibration setting).

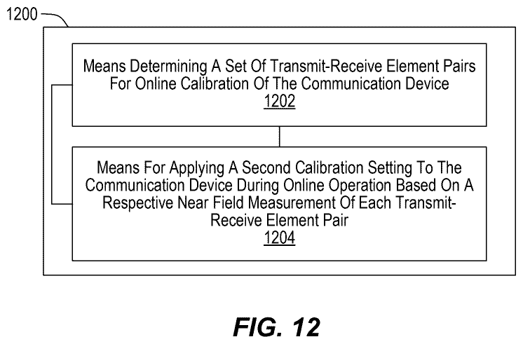

FIG. 12 is a functional block diagram of an apparatus including a mmW communication device including online calibration capabilities in accordance with some aspects of the disclosure. The apparatus 1200 comprises means 1202 as means for determining, at a communication device, a set of transmit-receive element pairs for online calibration of the communication device, wherein the communication device comprises a plurality of transmit elements coupled to a plurality of antenna elements and a plurality of receive elements coupled to the plurality of antenna elements. In some cases, a quantity of transmit elements in the set is less than a quantity of transmit elements in the plurality of transmit elements, and wherein a quantity of receive elements in the set is less than a quantity of receive elements in the plurality of transmit elements. The apparatus 1200 may optionally comprises means for performing a respective power measurement for each transmit element associated with a representative transmit element and corresponding receive element for the representative transmit element using a reference signal. The apparatus 1200 may optionally comprise means for determining a first calibration setting based on the respective power measurement of each transmit element. The apparatus 1200 may optionally comprise means for applying the first calibration setting to the communication device. The apparatus 1200 additionally comprises means 1204 as means for applying a calibration setting (e.g., the second calibration setting) to the communication device during online operation based on a respective near field measurement of each representative transmit element and corresponding receive element for the representative transmit element during the online operation, the calibration setting (e.g., the second calibration setting) being based on a respective predistortion coefficient for each transmit-receive element pair. The circuit architecture described herein may be implemented on one or more ICs, analog ICs, RFICs, mixed-signal ICs, application specific ICs (ASICs), PCBs, electronic devices, etc. The circuit architecture described herein may also be fabricated with various IC process technologies such as metal oxide semiconductor (MOS), complementary MOS (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the circuit described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

Although selected aspects have been illustrated and described in detail, it will be understood that various substitutions and alterations may be made therein without departing from the spirit and scope of the present invention, as defined by the following claims.

Although selected aspects have been illustrated and described in detail, it will be understood that various substitutions and alterations may be made therein without departing from the spirit and scope of the present invention, as defined by the following claims.

Illustrative aspects of the present disclosure include, but are not limited to:

Aspect 1. A communication device, comprising: an antenna array comprising a plurality of antenna elements; a plurality of transmit elements, wherein each transmit element is coupled to a corresponding antenna element of the plurality of antenna elements; a plurality of receive elements, wherein each receive element is coupled to an associated antenna element of the plurality of antenna elements; and control circuitry coupled to the plurality of transmit elements and the plurality of receive elements, the control circuitry configured to: determine a set of transmit-receive element pairs for online calibration of the communication device, wherein a quantity of transmit elements in the set is less than a quantity of transmit elements in the plurality of transmit elements, and wherein a quantity of receive elements in the set is less than a quantity of receive elements in the plurality of transmit elements; and apply a calibration setting to the communication device during online operation based on a respective near field measurement of each transmit-receive element pair during the online operation, the calibration setting based on a respective predistortion coefficient for each transmit-receive element pair.

Aspect 2. The communication device of Aspect 1, wherein the plurality of transmit elements and the plurality of receive elements are divided into different groups based on a physical arrangement, and wherein each group of the different groups includes a respective transmit element in the set of transmit-receive element pairs.

Aspect 3. The communication device of Aspect 2, wherein, to determine a representative transmit-receive element pair, the control circuitry is configured to: select a representative transmit element of the representative transmit-receive element pair from each group of transmit-receive elements, wherein the representative transmit element is selected based on average performance; transmit a signal from the representative transmit element in each group; and select a representative receive element for the representative transmit-receive element pair based on a received near field signal received by other receive elements excluding the representative receive element associated with the representative transmit element.

Aspect 4. The communication device of Aspect 3, wherein, to select the representative receive element, the control circuitry is configured to: correct a frequency error of each near field signal received by the other receive elements; reconstruct a signal from each received near field signal received by the other receive elements; determine an error based the reconstructed signal and the transmitted signal; and select the representative receive element based on the error.

Aspect 5. The communication device of any of Aspects 1 to 4, wherein the set of transmit-receive element pairs is stored in a non-volatile memory during an offline calibration.

Aspect 6. The communication device of any of Aspects 1 to 5, wherein the control circuitry is configured to: measure a power droop for each transmit element associated with a representative transmit-receive element pair at an output node of a representative transmit element using a reference signal.

Aspect 7. The communication device of Aspect 6, wherein a frequency associated with the power droop includes a signal region and an adjacent channel region.

Aspect 8. The communication device of any of Aspects 6 or 7, wherein the representative transmit element of the representative transmit-receive element pair is biased in a linear region during transmission of the reference signal.

Aspect 9. The communication device of any of Aspects 6 to 8, wherein the control circuitry is configured to: apply a second calibration setting to forward correct a combination of power droops measured for the set of transmit-receive element pairs during a mission mode of the communication device.

Aspect 10. The communication device of any of Aspects 6 to 9, wherein, to determine the calibration setting, the control circuitry is configured to: determine the respective predistortion coefficient for each transmit-receive element pair based on an online near field measurement of a reference signal transmitted and received by each representative transmit-receive element pair while individually correcting for the respective power droop measured for each transmit element each transmit element associated with a representative transmit-receive element pair.

Aspect 11. The communication device of any of Aspects 1 to 10, wherein the control circuitry is configured to: determine the calibration setting as an average of the respective predistortion coefficients for the set of transmit-receive element pairs.

Aspect 12. The communication device of Aspect 11, wherein the plurality of transmit elements are implemented on a plurality of integrated circuits, and wherein the set of transmit-receive element pairs comprises one transmit element from each integrated circuit.

Aspect 13. A method comprising: determining, at a communication device, a set of transmit-receive element pairs for online calibration of the communication device, wherein the communication device comprises a plurality of transmit elements coupled to a plurality of antenna elements and a plurality of receive elements coupled to the plurality of antenna elements, wherein a quantity of transmit elements in the set is less than a quantity of transmit elements in the plurality of transmit elements, and wherein a quantity of receive elements in the set is less than a quantity of receive elements in the plurality of transmit elements; and applying a calibration setting to the communication device during online operation based on a respective near field measurement of each transmit-receive element pair during the online operation, the calibration setting based on a respective predistortion coefficient for each transmit-receive element pair.

Aspect 14. The method of Aspect 13, wherein the plurality of transmit elements and the plurality of receive elements are divided into different groups based on a physical arrangement, wherein each group of the different groups includes a respective transmit element in the set of transmit-receive element pairs.

Aspect 15. The method of any of Aspects 13 or 14, further comprising determining a representative transmit-receive element pair, comprising: selecting a representative transmit element of the representative transmit-receive element pair from each group of transmit-receive elements, wherein the representative transmit element is selected based on average performance; transmitting a signal from the representative transmit element in each group; and selecting a representative receive element for the representative transmit-receive element pair based on a received near field signal received by other receive elements excluding the representative receive element associated with the representative transmit element.

Aspect 16. The method of Aspect 15, wherein selecting the representative receive element further comprises: correcting a frequency error of each near field signal received by the other receive elements; reconstructing signal from each received near field signal received by the other receive elements; determining an error based the reconstructed signal and the transmitted signal; and selecting the representative receive element based on the error.

Aspect 17. The method of any of Aspects 13 to 16, wherein the set of transmit-receive element pairs is stored in a non-volatile memory during an offline calibration.

Aspect 18. The method of any of Aspects 13 to 17, further comprising: measuring a power droop for each transmit element associated with a representative transmit-receive element pair at an output node of a representative transmit element using a reference signal.

Aspect 19. The method of Aspect 18, wherein a frequency associated with the power droop includes a signal region and an adjacent channel region.

Aspect 20. The method of any of Aspects 18 or 19, wherein the representative transmit element of the representative transmit-receive element pair is biased in a linear region during transmission of the reference signal.

Aspect 21. The method of any of Aspects 18 to 20, further comprising: applying a second calibration setting to forward correct a combination of power droops measured for the set of transmit-receive element pairs during a mission mode of the communication device.

Aspect 22. The method of any of Aspects 18 to 21, wherein determining the second setting comprises: determining the respective predistortion coefficient for each transmit-receive element pair based on an online near field measurement of a reference signal transmitted and received by each representative transmit-receive element pair while individually correcting for the respective power droop measured for each transmit element each transmit element associated with a representative transmit-receive element pair.

Aspect 23. The method of any of Aspects 13 to 22, further comprising: determining the calibration setting as an average of the respective predistortion coefficients for the set of transmit-receive element pairs.

Aspect 24. The method of Aspect 23, wherein the plurality of transmit elements are implemented on a plurality of integrated circuits, and wherein the set of transmit-receive element pairs comprises one transmit element from each integrated circuit.

Aspect 25. A non-transitory computer-readable medium having stored thereon instructions that, when executed by at least one processor, cause the at least one processor to perform operations according to any of Aspects 13 to 24.

Aspect 26. An apparatus for performing a function, comprising one or more means for performing operations according to any of Aspects 13 to 24.

What is claimed is:

1. A communication device, comprising:
an antenna array comprising a plurality of antenna elements;
a plurality of transmit elements, wherein each transmit element is coupled to a corresponding antenna element of the plurality of antenna elements;
a plurality of receive elements, wherein each receive element is coupled to an associated antenna element of the plurality of antenna elements; and
control circuitry coupled to the plurality of transmit elements and the plurality of receive elements, the control circuitry configured to:
determine a set of transmit-receive element pairs for online calibration of the communication device, wherein a quantity of transmit elements in the set is less than a quantity of transmit elements in the plurality of transmit elements, and wherein a quantity of receive elements in the set is less than a quantity of receive elements in the plurality of transmit elements; and
apply a calibration setting to the communication device during online operation based on a respective near field measurement of each transmit-receive element pair during the online operation, the calibration setting based on a respective predistortion coefficient for each transmit-receive element pair.

2. The communication device of claim 1, wherein the plurality of transmit elements and the plurality of receive elements are divided into different groups based on a physical arrangement, and wherein each group of the different groups includes a respective transmit element in the set of transmit-receive element pairs.

3. The communication device of claim 2, wherein, to determine a representative transmit-receive element pair, the control circuitry is configured to:
select a representative transmit element of the representative transmit-receive element pair from each group of transmit-receive elements, wherein the representative transmit element is selected based on average performance;
transmit a signal from the representative transmit element in each group; and
select a representative receive element for the representative transmit-receive element pair based on a received near field signal received by other receive elements excluding the representative receive element associated with the representative transmit element.

4. The communication device of claim 3, wherein, to select the representative receive element, the control circuitry is configured to:
correct a frequency error of each near field signal received by the other receive elements;
reconstruct a signal from each received near field signal received by the other receive elements;
determine an error based the reconstructed signal and the transmitted signal; and
select the representative receive element based on the error.

5. The communication device of claim 1, wherein the set of transmit-receive element pairs is stored in a non-volatile memory during an offline calibration.

6. The communication device of claim 1, wherein the control circuitry is configured to:
measure a power droop for each transmit element associated with a representative transmit-receive element pair at an output node of a representative transmit element using a reference signal.

7. The communication device of claim 6, wherein a frequency associated with the power droop includes a signal region and an adjacent channel region.

8. The communication device of claim 6, wherein the representative transmit element of the representative transmit-receive element pair is biased in a linear region during transmission of the reference signal.

9. The communication device of claim 6, wherein the control circuitry is configured to:
apply a second calibration setting to forward correct a combination of power droops measured for the set of transmit-receive element pairs during a mission mode of the communication device.

10. The communication device of claim 6, wherein, to determine the calibration setting, the control circuitry is configured to:
determine the respective predistortion coefficient for each transmit-receive element pair based on an online near field measurement of a reference signal transmitted and received by each representative transmit-receive element pair while individually correcting for the respective power droop measured for each transmit element each transmit element associated with a representative transmit-receive element pair.

11. The communication device of claim 1, wherein the control circuitry is configured to:
determine the calibration setting as an average of the respective predistortion coefficients for the set of transmit-receive element pairs.

12. The communication device of claim 11, wherein the plurality of transmit elements are implemented on a plurality of integrated circuits, and wherein the set of transmit-receive element pairs comprises one transmit element from each integrated circuit.

13. A method comprising:
determining, at a communication device, a set of transmit-receive element pairs for online calibration of the communication device, wherein the communication device comprises a plurality of transmit elements coupled to a plurality of antenna elements and a plurality of receive elements coupled to the plurality of antenna elements, wherein a quantity of transmit elements in the set is less than a quantity of transmit elements in the plurality of transmit elements, and wherein a quantity of receive elements in the set is less than a quantity of receive elements in the plurality of transmit elements; and
applying a calibration setting to the communication device during online operation based on a respective near field measurement of each transmit-receive element pair during the online operation, the calibration setting based on a respective predistortion coefficient for each transmit-receive element pair.

14. The method of claim 13, wherein the plurality of transmit elements and the plurality of receive elements are divided into different groups based on a physical arrangement, wherein each group of the different groups includes a respective transmit element in the set of transmit-receive element pairs.

15. The method of claim 13, further comprising determining a representative transmit-receive element pair, comprising:
selecting a representative transmit element of the representative transmit-receive element pair from each group of transmit-receive elements, wherein the representative transmit element is selected based on average performance;
transmitting a signal from the representative transmit element in each group; and
selecting a representative receive element for the representative transmit-receive element pair based on a received near field signal received by other receive elements excluding the representative receive element associated with the representative transmit element.

16. The method of claim 15, wherein selecting the representative receive element further comprises:
correcting a frequency error of each near field signal received by the other receive elements;
reconstructing signal from each received near field signal received by the other receive elements;
determining an error based the reconstructed signal and the transmitted signal; and
selecting the representative receive element based on the error.

17. The method of claim 13, wherein the set of transmit-receive element pairs is stored in a non-volatile memory during an offline calibration.

18. The method of claim 13, further comprising:
measuring a power droop for each transmit element associated with a representative transmit-receive element pair at an output node of a representative transmit element using a reference signal.

19. The method of claim 18, wherein determining the calibration setting comprises:
determining the respective predistortion coefficient for each transmit-receive element pair based on an online near field measurement of a reference signal transmitted and received by each representative transmit-receive element pair while individually correcting for the respective power droop measured for each transmit element each transmit element associated with a representative transmit-receive element pair.

20. The method of claim 13, further comprising:
determining the calibration setting as an average of the respective predistortion coefficients for the set of transmit-receive element pairs.
